(19) United States
(12) Patent Application Publication
(10) Pub. No.: US 2007/0250769 A1
(43) Pub. Date: Oct. 25, 2007

(54) Method and system to provide online application forms

(75) Inventors: Michael Bass, Livermore, CA (US); Jiang Wu, Redwood City, CA (US); Stefan Reicheneder, San Francisco, CA (US); Sheldon X. Wang, San Rafael, CA (US)

Correspondence Address: SCHWEGMAN, LUNDBERG & WOESSNER, P.A., P.O. BOX 2938, MINNEAPOLIS, MN, 55402, US

(73) Assignee: EHEALTHINSURANCE SERVICES, INC.

(21) Appl. No.: 11/410,350

(22) Filed: Apr. 24, 2006

(51) Int. Cl. G06F 15/00; G06F 17/00

(52) U.S. Cl. 715/523

(57) ABSTRACT

A method and system to provide an application form via a network (e.g., the Internet) is described. The method may comprise accessing page flow data, page data and rules data stored in a storage media and generating a GUI that provides a first application page to capture data from an applicant. The first page is generated dynamically from the page data and provided to the applicant. Application data entered by the applicant is processed, stored, and validated based on the rules data. At least one subsequent application page is identified based on the application data and the page flow data and is provided to the applicant via the network. The subsequent application page is also generated dynamically and on-the-fly from the page data. Subsequent application pages are dynamically and repetitively generated and provided to the applicant based on the page flow data and the rules data.

### FIELD

The present application relates generally to the field of building or providing forms, for example, building or providing online application forms.

### BACKGROUND

Websites now enable users to obtain insurance (e.g. health insurance) online via the Internet. Typically, such websites include a plurality of health insurance providers each of which provides a plurality of different health insurance products. The health insurance providers, such as the health insurance carriers, who underwrite and issue health insurance policies, and the brokers or agents who sell those policies or plans (plan brokers), must strictly comply with federal laws that regulate security, privacy and personal medical information (e.g., comply with The Health Insurance Portability and Accountability Act of 1996; Gramm-Leach Bliley Act of 1999, and so on).

As a result of the aforementioned, health insurance plans are not only applicant specific but also geographical location specific. Further, it will be appreciated that the information required from a user in order to ascertain which insurance plan is appropriate for the user may differ from applicant to applicant. Each health insurance product may have its own customized application form.

Prior art systems “hardcode” these application forms (e.g., from a hardcopy or a PDF of the form) using HTML. Thus, each application form is mapped to an HTML document which is stored and rendered online to an applicant via the Internet. Further, should changes be required in any application form, the HTML hardcoded HTML is modified.

This complexity in the health insurance forms is due, in part, to how heavily regulated the health insurance industry is and strictness in the underwriting requirements. However, the same issues arise in other industries (e.g., the banking industry, short-term and long-term insurance industry, college application, or the like).

### SUMMARY

According to an example embodiment, there is provided a system and a method to build or provide online application forms.

The invention extends to a machine-readable medium including instructions for performing any one or more of the methodologies described herein.

Other features will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, and in which like references indicate the same or similar elements.

In the drawings,

FIG. 1 shows a system, in accordance with an example embodiment, to build online application forms;

FIG. 2 shows example conceptual architecture of the system of FIG. 1;

FIG. 3 shows an example graphical user interface (GUI) generated by a form builder, in accordance with an example embodiment;

FIG. 4 shows example components or modules of a example form builder in accordance with an example embodiment;

FIG. 5 shows a method, in accordance with an example embodiment, performed by a page flow editor;

FIG. 6 shows a method, in accordance with an example embodiment, to perform HTML processing in response to a user's page building action;

FIG. 7 shows a method, in accordance with an example embodiment, to automatically edit or process rules when building an online application form;

FIG. 8 shows an example graphical user interface (GUI), in accordance with an example embodiment, to allow a user to provide and edit rules;

FIG. 9 shows a wizard, in accordance with an example embodiment, to assist a user in generating and online application form;

FIG. 10 shows an example template library of the system of FIG. 1 for the health insurance industry;

FIG. 11 shows examples of core-data, in accordance with an example embodiment, in a health insurance application form;

FIG. 12 shows examples of other-data, in accordance with an example embodiment, in the health insurance application form;

FIGS. 13A and B shows an example graphical user interface including an HTML editor tab, a rules editor tab, and a preview tab. FIG. 13A also shows, by way of example, a Data tab on a left panel while FIG. 13B shows a Page Component Tab.

FIG. 14A shows an example display area of a GUI that provides the reference pages, in accordance with an example embodiment;

FIGS. 14B-14E show example application forms that may be built and subsequently rendered by a runtime engine;

FIGS. 15-17 show pop-up windows that allow a user to define pre-qualification questions;

FIGS. 18 and 19 show a pop-up windows that allow a user to define a conditional transition;

FIG. 20 shows GUI of a template library window, in accordance with an example embodiment;

FIGS. 21-23 show example pop-up windows that allow a user to create a new template;

FIGS. 24-27 show example pop-up windows that allow a user to create new data elements for a new template;

FIGS. 28-34 show example pop-up windows or screens displayed by a wizard, in accordance with an example embodiment;

FIGS. 35-68 show example pop-up windows generated by the system of FIG. 1;

FIG. 69 shows a diagrammatic representation of a machine in the example form of a computer system for performing any one or more of the methodologies described herein;

FIG. 70 shows a system, in accordance with an example embodiment, including a form builder that creates a data model and a runtime engine to create application documents on-the-fly from the data model;

FIG. 71 shows an example data model including core-data and non-core-data used by a runtime engine to generate pages of an application form on-the-fly;

FIG. 72 shows example page flow data included in an application manifest;

FIG. 73 shows a method, in accordance with an example embodiment, for rendering documents to an applicant via a network;

FIG. 74 shows a method, in accordance with an example embodiment, to update data in an XML data structure or model;

FIG. 75 shows a method, in accordance with an example embodiment, to validate data or information entered by the applicant;

FIG. 76 shows data flow to control screen flow logic which defines a sequence in which pages are to be presented to an applicant; and

FIG. 77 shows example data flow for persistence of data generated during runtime.

### DETAILED DESCRIPTION

A method and system to build online application forms (e.g., a health insurance application forms) are described. In the following description, for purposes of explanation, numerous specific details are set forth in order to provide a thorough understanding of example embodiments of the present invention. It will be evident, however, to one skilled in the art that the present invention may be practiced without these specific details. In an example embodiment, the method may comprise providing a graphical user interface (GUI) to a user, the GUI including page layout zone and a page type zone include a plurality of reference page types; monitoring user placement of selected reference page types in the page layout zone; automatically interconnecting the selected reference page types based on their relative placement in the page layout zone, wherein page flow data defines a sequence in which the selected pages are to presented in the application form; automatically associating rules provided in a reference database associated with each reference page type, wherein rule data defines the content of each reference page type; and storing the interconnection data (or page flow data) and the page data (e.g., page templates) in a storage media (such as a computer file system) for subsequent conversion to web-based markup language.

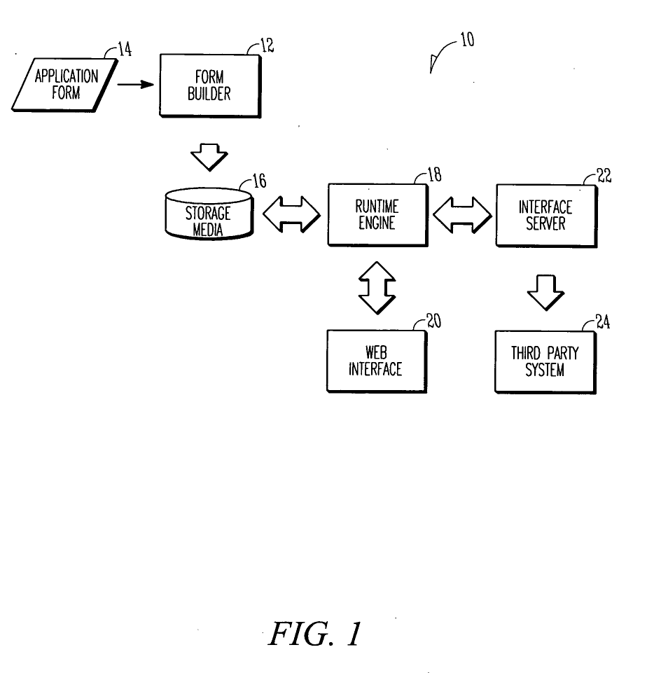

Referring to FIG. 1, reference 10 generally indicates a system, in accordance with an example embodiment, to build an application form, for example, an online application form. The system 10 includes a form builder 12 which allows a user to build an electronic application form based on, for example, a hardcopy 14 (including a PDF document, or any other non-editable document) of the application form. The system 10 is also shown to include storage media 16 (e.g., a database) with which, as described in more detail below, the form builder 12 interacts. Thus, in an example embodiment, data to construct or generate an electronic form (e.g., an application form) is stored in the storage media 16 and, at runtime, the runtime engine 18 dynamically and on-the-fly provides online application pages or web pages via a Web interface 20. For example, the Web interface 20 may interface the system 10 to the Internet thus allowing remote users to make online applications wherein the application forms are generated on-the-fly by the runtime engine 18. One or more components of the system 10 may be provided by a client device such as a personal computer or the like.

The system 10 is also shown to include an interface server 22 that interfaces the runtime engine 18 to a third party system 24. As the runtime engine 18 generates application forms on-the-fly from a pre-defined data structure in the storage media 16, specific predetermined or preconfigured application forms or forms are not required. Thus, in an example embodiment, the runtime engine 18 may generate a specific application form that is appropriate for a particular applicant applying for a particular health insurance product and not merely provide a pre-configured application form to the applicant. Thus a specific application form, that is dependent upon the specific details provided by a user online while completing an application form, may be generated on-the-fly by the system 10.

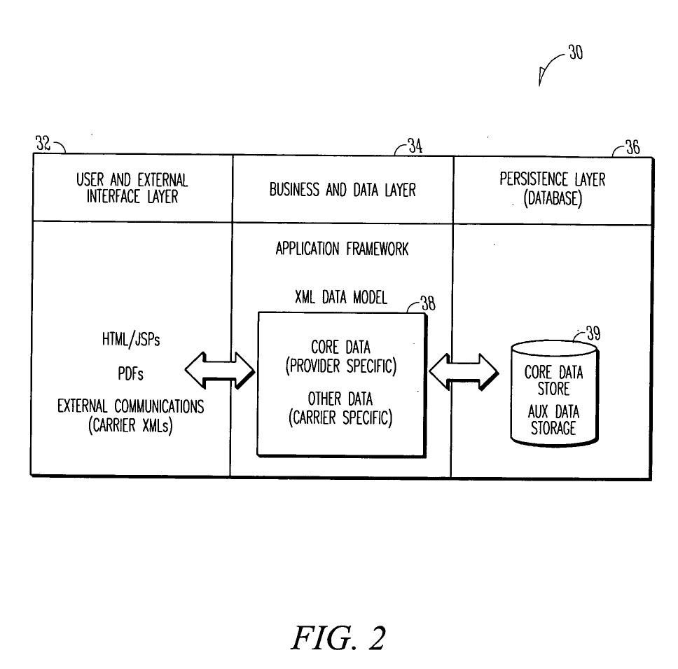

Referring to FIG. 2, reference the 30 generally indicates example conceptual architecture of the system 10. The architecture 30 is shown to include a user and external interface layer 32, a business and data layer 34, and a persistence layer 36. The business and data layer 34 may, in an example embodiment, include an application framework and data model 38 (e.g., an XML data model). The data model 38 may include core-data that are common to multiple application forms (e.g., from multiple health insurance carriers) as well as other data that are specific to a product provider (or application form) offered by the system provider (e.g., data specific to a particular health insurance carrier). The persistence layer 36 stores the core-data and other-data (examples of which is provided below) of insurance applicants in storage media (e.g., a database 39). The user and external interface layer 32 may correspond to the Web interface 20 and include HTML/JSP functionality, PDF functionality, and external communication functionality (e.g., exchanging application data with health insurance carriers). In an example embodiment, the runtime engine 18 utilizes the application form data to generate a user interface and stores applicant inputs (e.g., applicant data) into the data model. The data model may be automatically mapped into the database 39 for permanent storage.

In an example embodiment, the storage media 16 may include data related to the application form being built (e.g., an XML schema). The data subsequently received from the applicant when completing a fully built on-line application document may be stored in the database 39. It is however to be appreciated that the applicant data and application form data may be combined or distributed in any suitable way amongst one or more databases.

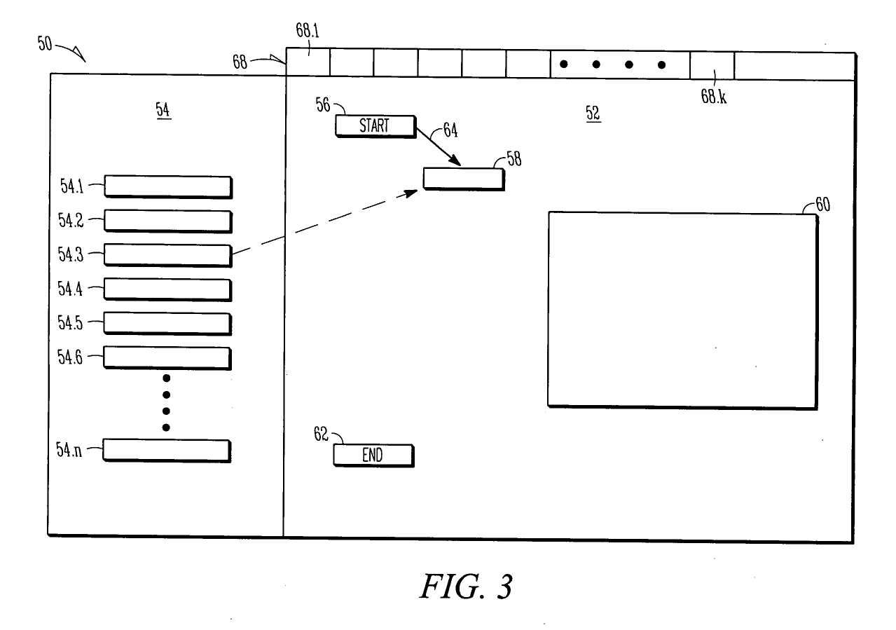

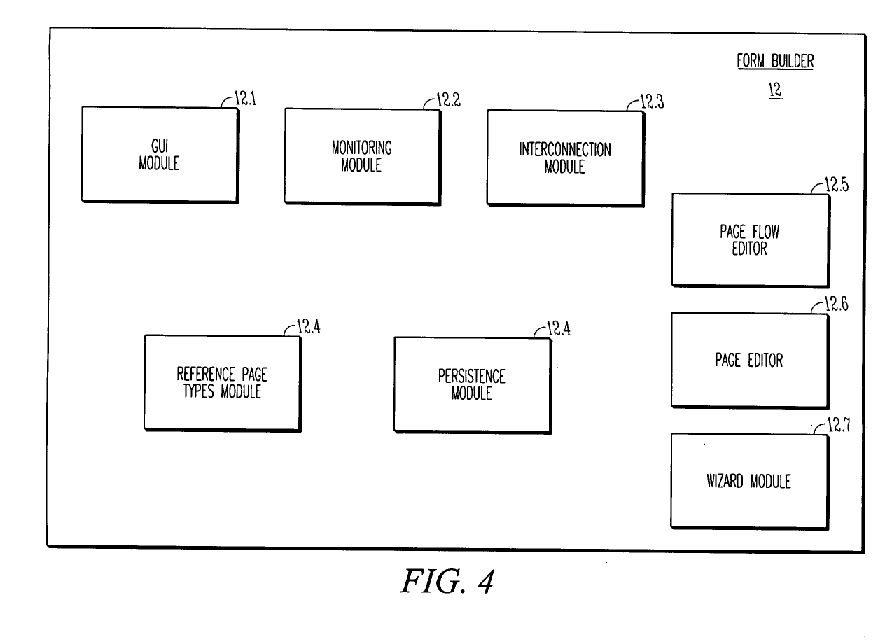

FIG. 3 shows an example graphical user interface (GUI) 50 generated by the example form builder 12 (see FIG. 1). FIG. 4 shows example components or modules of the form builder 12 shown in FIG. 1. The graphical user interface 50 includes a page layout zone 52 and a page type zone 54 that includes a plurality of reference page types 54.1-54.n. The graphical user interface 50 may be generated by a GUI module 12.1 as shown in FIG. 4. In an example embodiment, when a user initiates the creation of a new page (e.g., a new page of a dynamic online document) an initial start node 56 is automatically provided in the page layout zone 52. Thereafter, a user may use a pointing device (e.g., a computer mouse) and drag a selected reference page (e.g. reference page 54.3) into the page layout zone 52 to create a new page 58 in the application form that the user is building. Thus, the form builder 12 may include a monitoring module 12.2 that monitors a user interaction with the system 10. In an automated fashion, and without user intervention, the system 10 may interconnect the initial start node 56 and the new page 58 (e.g., the form builder 12 may perform this functionality using an interconnection module (or page flow module) 12.3). The interconnection module 12.3 automatically creates the necessary page links defined using, for example, a data structure in XML format, so that the runtime engine 18 automatically, and in the sequence defined in the page layout zone 52, presents the pages to an applicant (e.g., a person completing an online application form). A page flow editor 12.5 allows a user to edit or define the flow of pages that the runtime engine 18 will present to the user during the application process. As described in more detail with reference to the runtime engine 18, it should be noted that, in an example embodiment, not all pages built by the user may be rendered and displayed to the applicant during an application process. In an example embodiment, the interconnection data and the page data is stored in the storage media 16 and provides an abstraction layer between the online application form and an HTML page generated from the interconnection data and the page data. The interconnection data and the page data may be Extensible Markup Language (XML) which is for subsequent conversion to Hyper Text Transfer Protocol Language (HTML).

In the GUI 50 a user may select any one or more of the reference page types 54.1-54.n (see reference page types module 12.4) and thereby create or build a dynamic online application form. It will be appreciated that the specific nature of the reference page types 54.1-54.n may be dependent upon the specific application form that is being built. For example, in an online health insurance environment, the reference page types 54.1-54.n may include relevant health insurance information that should be obtained from an applicant as required by a specific health insurance carrier in a particular geographical area (e.g., a particular state). However, in other embodiments, the reference page types 54.1-54.n may include other information (e.g., car insurance data, application data for an educational institution, or the like).

It will be appreciated that an application form being built by a user need not only comprise predefined reference pages but also customized pages. Accordingly, the system 10 using the graphical user interface 50 allows a user to customize one or more application pages. For example, in order to allow a user to customize an application page one or more pop-up windows 60 may be generated and include functionality, as described in more detail below, to allow a user to generate a customized application page for a customized application form. After a user has completed the layout and definition of the pages required in the electronic application form, an end node 62 may be selected.

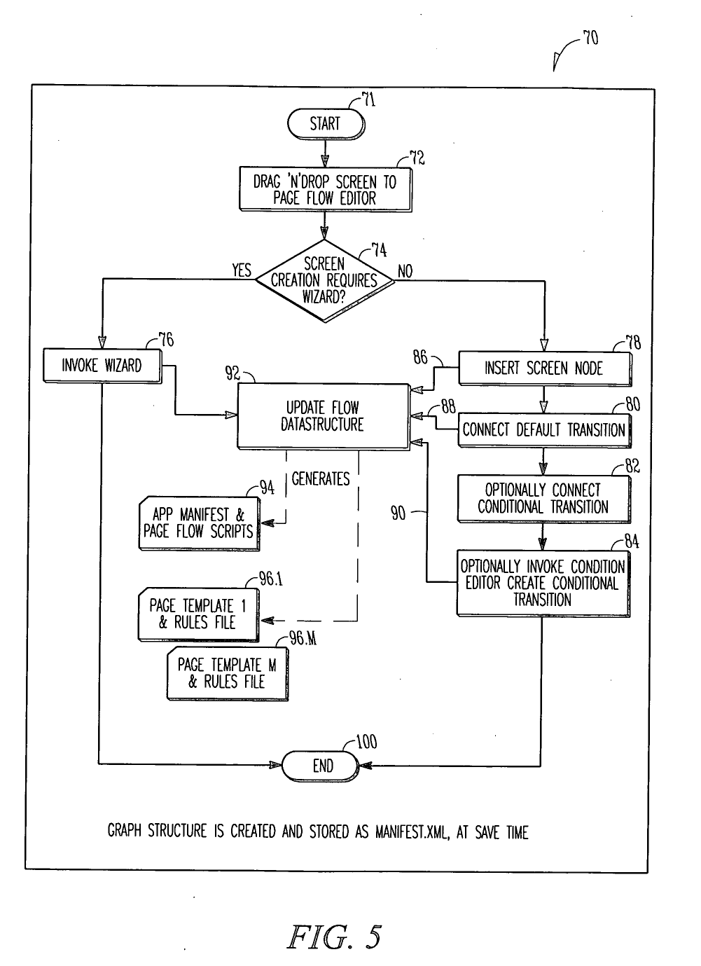

FIG. 5 shows a method 70, in accordance with an example embodiment, performed by a page flow editor (e.g., the page flow editor 12.5). The method 70 allows a user to define pages as well as the potential sequence or page flow (which may be determined at runtime) in which they will be displayed to an applicant. After a user has invoked the method 70 (see block 71), monitoring is performed at block 72 to detect a drag and drop operation (see for example the monitoring module 12.2 in FIG. 4). For example, the user may drag and drop one of the references pages 54.1-54.n into the page layout zone 52. Thereafter, as shown at decision block 74, the method 70 determines if the user has selected use of a wizard to assist in building one or more pages of the application form. If so, as shown at block 76, the wizard is invoked. In an example embodiment the wizard may be invoked automatically and further example details of the wizard are described below.

However, as shown at block 78, if the user has not selected use of the wizard then a screen node (e.g., a screen node defining new page 58) is inserted into the page layout zone 52. A default transition (represented by line 64 in FIG. 3 and block 80 in FIG. 5) between a previous node (e.g., the initial start node 56) and the currently inserted node (e.g., new page 58) is automatically established (see for example the interconnection module 12.3). The method 70 then provides an optional operation (see block 82) whereby the user can create a conditional page transition. For example, when Web documents are subsequently rendered to an applicant completing the already built application form, the current page rendered to the applicant may be dependent upon a condition. For example, in the health insurance environment, if an earlier page requests a user to indicate if he or she has previously had a prior health condition and the user answers in the affirmative, then a conditional page transition is performed presenting the user with more specific questions about the prior health condition. In order to customize or define a conditional page transition, a condition editor (see block 84) may be invoked.

As shown by lines 86-90, functionality performed in the blocks 78-84 may update a page flow data structure as shown in block 92. Upon completion of building the application form, a data set (e.g., an XML data set) is generated which is then used to generate an ‘application manifest’ and page flow scripts 94, and page template rules files 96.1-96.m. As in the case of the manual creation utilizing the processes in blocks 78-84, the wizard (see block 76) also updates the data structure (see arrow 98).

Thus, in an example embodiment, the method 70 may define the underlying logic that deals with the page flow editor 12.5 which allows a user to define the content and sequence of pages in the application form. In an example embodiment, the method 70 may first determine if a particular reference page 54.1-54.n can simply be dragged and dropped by the user, or whether the reference page 54.1-54.n requires use of the wizard. In these circumstances, the wizard may be invoked automatically to assist the user to build one or more associated pages.

An example where the wizard may not be required may be when a reference page 54.1-54.m relates to a generic screen (e.g., a GUI presented to an applicant at runtime). An example of such a generic screen may be requesting geographical details of the user (e.g. requesting zip code of the user). It will be appreciated that, various predefined screens may be provided to request simple information from the applicant. However, in more complex scenarios where multiple screens or related information is required the wizard may be used. The method 70 allows a user to end the electronic form building methodology at block 100.

In an example embodiment, an internal data structure may be associated with each node. For example, the new page 58 may define a data node and, associated therewith, there may be an internal data structure which defines when the particular new page 58 should be presented to an applicant by the runtime engine 18. The internal data structure may also define the contents of the new page 58. It should be noted that the method 70 automatically creates the necessary data structure and that, from a user perspective, the only input required from the user is the dragging and dropping of the selected reference page 54.1-54.n and all the page interconnections and data structures are automatically created. In FIG. 5, operations carried out in blocks 72, 76, and 82 may require user action or input. However, operations carried out in blocks 71, 74, 78, 80, 92, and 100 may be automated actions performed without human intervention by the method 70. In blocks 94 and 96.1-96.m data files are generated which are subsequently used by the runtime engine 18 to present application forms on-the-fly to the applicant.

Each node in the page layout zone 62 (e.g. the new page 58, the initial start node 56, and the end node 62) may also be represented as a node in the internal data structure (see block 92 in FIG. 5). In an example embodiment, the method 70 may as a default create the page transition 64 that goes from the previous node to a newly added node without any conditions. For example, the method 70 may automatically create a direct transition from the initial start node 56 to the new page 58. The user may then subsequently add a conditional transition as shown at block 82 in FIG. 5. In an example embodiment, the user may change the defaults or create new transitions by reconfiguring existing arrows that represent transitions. Each new page added may have associated page template data that defines the content of the page (look and feel) and also have associated page flow data in the application manifest that dictates when the page will (if ever) be presented to an applicant at runtime.

In an example embodiment, the application manifest and page flow scripts 94 and the page template and rules files 96.1-96.m are generated when the user saves an application form definition file that is generated in block 92. In an example embodiment, the application definition file is an XML file used by the runtime engine 18 to generate and provide electronic application forms via the Web interface 20. Each page of the page template and rules files 96.1-96.m may represent a screen that is to be presented to the applicant.

The application manifest may describe or define the various pages and their transitions (e.g., based on applicant input). Accordingly, in an example embodiment, the application manifest file may describe the pages for presentation to the applicant in XML as well as their transitions. Page templates may describe the details of each page. As described in more detail below, the rules files may define business rules associated with a particular health insurance provider. In an example embodiment, the rules are retrieved from a rules library which includes sets of rules each associated with application provider (e.g., applications forms of a health insurance provider).

Although example embodiments are described by way of example with reference to the health insurance industry, it will be appreciated that the form builder 12 may be used to build any electronic application forms. It will be appreciated that a wizard may be customized to build electronic forms for a particular industry by posing a series of questions to a user building the application form.

In an example embodiment, the flow of pages in the electronic application forms may be defined and thereafter the actual pages may be designed. It is however to be appreciated that the page layout and the actual design of the pages may be performed in any sequence. For example the user or form builder may perform the actual page design prior to completion of the total page layout of the entire application form.

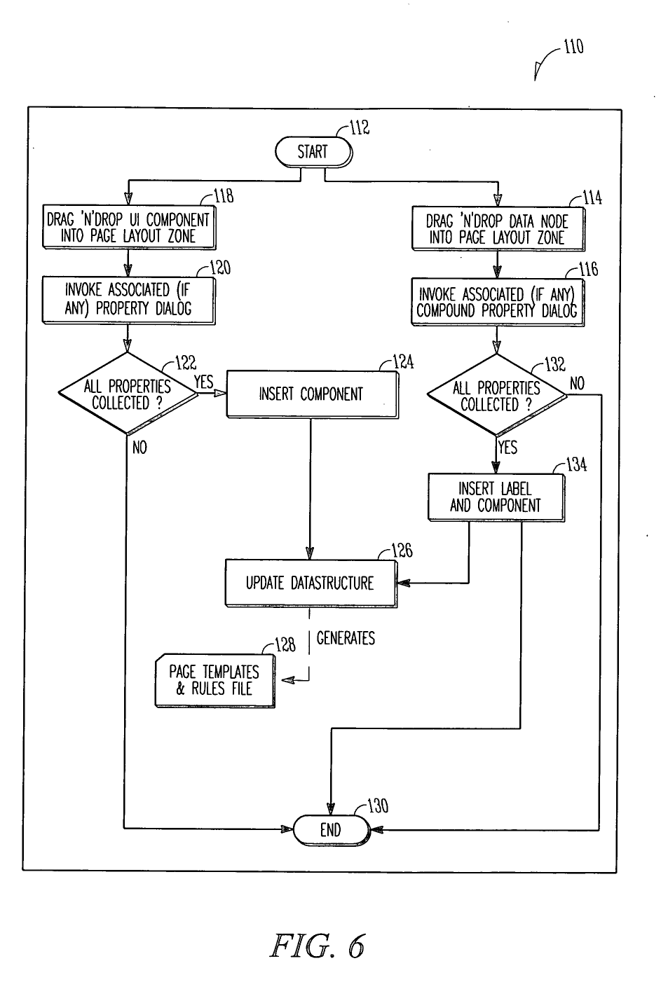

FIG. 6 shows a method 110, in accordance with an example embodiment, to perform page design/build an application form in response to a user's page building action. As shown at start 112, a user action may invoke the method 110 to start a page design. Thereafter, the method 110 monitors at block 114 if the user drags and drops a data node (e.g., one of the reference pages 54.1-54.n) into the page layout zone 52. If so, as shown at block 116, the method 110 may invoke an associated (if any) compound property dialog. Likewise, the method 110 may monitor at block 118 if the user drags and drops a user interface (UI) component 68.1-68.k (see FIG. 3) from a UI toolbar 67 into the page layout zone 52. As described in more detail below, the user interface components 68.1-68.k may include a plurality of predefined HTML building blocks to facilitate creation of a new online application document or form. In an example embodiment, the user may customize, add and remove UI components.

As shown at block 120, when a user drags and drops a UI component 68.1-68.k the method 110 may invoke an associated (if any) property dialog. Thereafter, as shown in decision block 122, the method 110 determines if all properties have been collected and, if so, the method 110 proceeds to block 124 where the UI component is then inserted. Thereafter, as shown at block 126, the editor data structure is updated and page templates and rules files are generated (see block 128). Returning to decision block 122, if all properties have not been collected then the method 110 proceeds to end 130. The method 110 then continually monitors the dragging and dropping of any further UI components into the page layout zone 52.

Returning to block 116 when an associated compound property dialog is generated in response to dragging and dropping a node into the page layout zone 52, a check is conducted at decision block 132 and, if all properties had been collected, the method 110 proceeds to block 134 where the label and component is inserted into the data structure and, as shown at block 126, the data structure is updated. Thereafter, as shown at block 128, page templates and rules files based on the user input are generated. If, however, all properties have not been collected, then the method 110 proceeds to end block 130 and awaits further user input. In the example method 110, a single page and template rules file is generated as shown at block 128. Further, blocks 112, 114, 118, and 130 require a user input. Functionality in blocks 116, 120, 124, 126, 128, and 134 is automatically performed, without human intervention, by the method 110.

In an example embodiment at least one of the UI components 68.1-68.k allows a user to define a table by dragging and dropping a table UI component into the page layout zone. Thus, when the user drags the table UI component (described by way of example in more detail below) into the page layout zone 52 a grid may be generated and displayed in the pop-up window 60. In response thereto, a wizard may automatically be invoked that obtains details/parameters from the user to define a number of columns, a number of rows, or the like. Further, the wizard may request details for a heading that is required for the table and any other relevant data. Thus, the UI components 68.1-68.k may allow a user to define various structures that will be displayed on a screen/page when it is generated by the runtime engine 18. In an example embodiment, various other UI components may be dragged and dropped into the grid that is generated. Thus, the UI components may allow a user to customize particular sections or parts of a table, generate tables and grids, label tables (e.g., columns and rows), add drop-down menus, check boxes, or the like. It will be appreciated, however, that the specific nature of the UI components may differ when the method 110 is customized for different industries. For example, different UI components may be provided in the health insurance industry to those provided in application forms for educational institutions. Thus, the UI components allow a user to select a predefined structure and define the content within the structure using further UI components. As described in more detail below, the UI components may define a data tree which is specific to a particular industry (the example the health insurance industry).

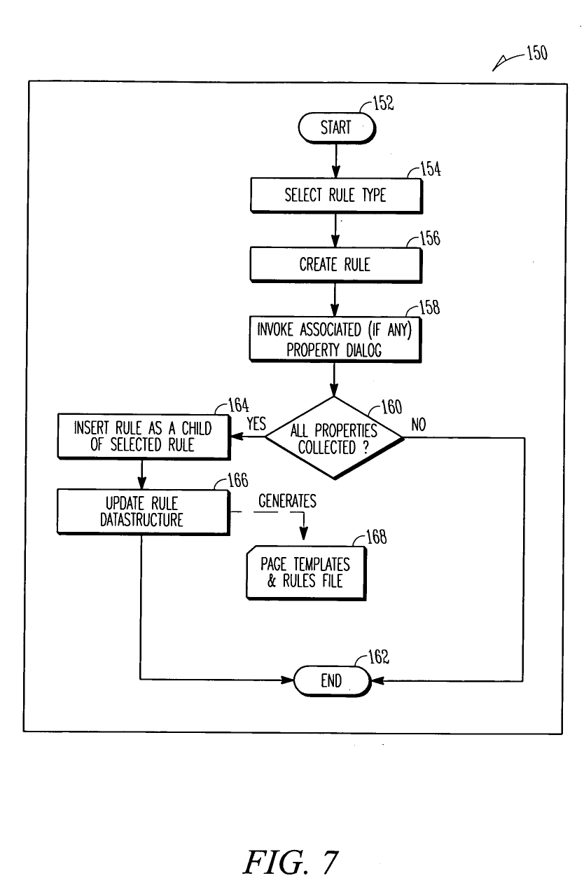

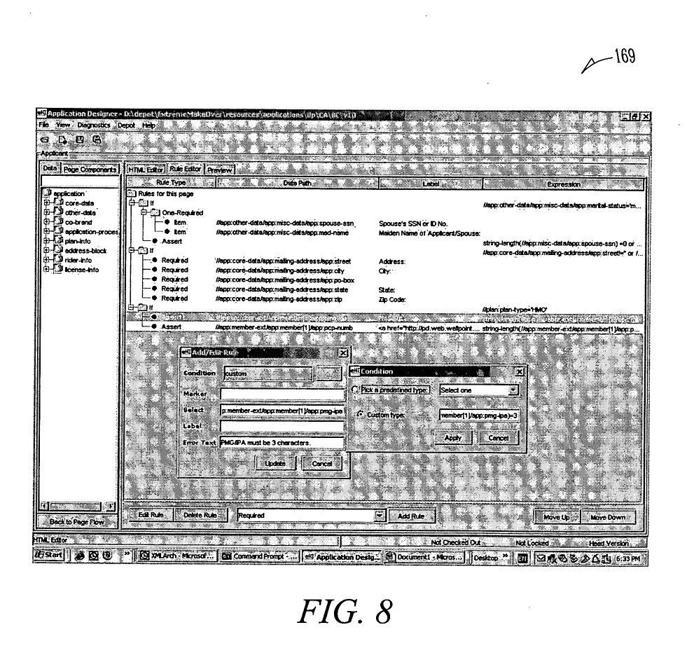

Referring to FIG. 7, reference 150 generally indicate a method, in accordance with an example embodiment, to automatically create or edit or rules (e.g., business rules) when building an online application form. When the user invokes the method 150 (see start 152 which may correspond to starts 71 and 112 in FIGS. 5 and 6 respectively), a user is required to select a rule type as shown at block 154, where after in an automated fashion, and without human intervention, the method 150 automatically creates the rule (see block 156). Once the form designer has initiated creating rules, the method 150 automatically invokes an associated (if any) property dialog at block 158 where after, at decision block 160, a determination is made whether or not all properties have been collected. If all properties have not been collected, then the method 150 proceeds to end 162 and awaits further input from the user. If, however, all properties have been collected, then the method 150 proceeds to block 164 and inserts a rule as a child of a selected rule. Thereafter, as shown at block 166, the method 150 updates a rule data structure and generates page templates and a rules file as shown at 168. In an example embodiment, the functionality performed in blocks 158, 164 and 166 is performed in an automated fashion without human intervention. An example graphical user interface (GUI) 169 that provides an example business rules editor is shown in FIG. 8 and is described in more detail below.

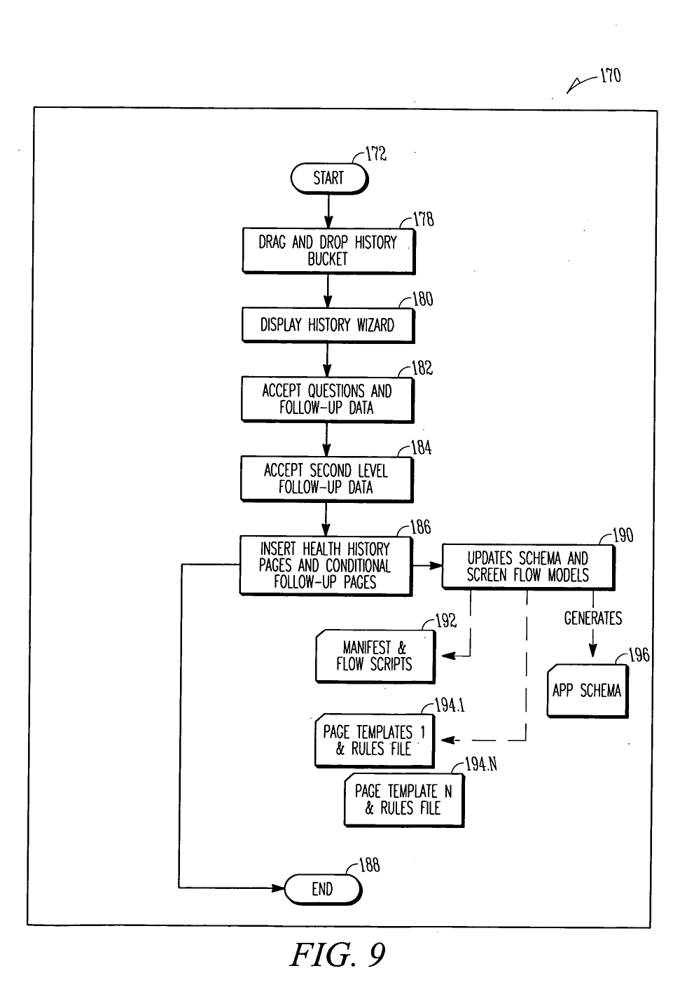

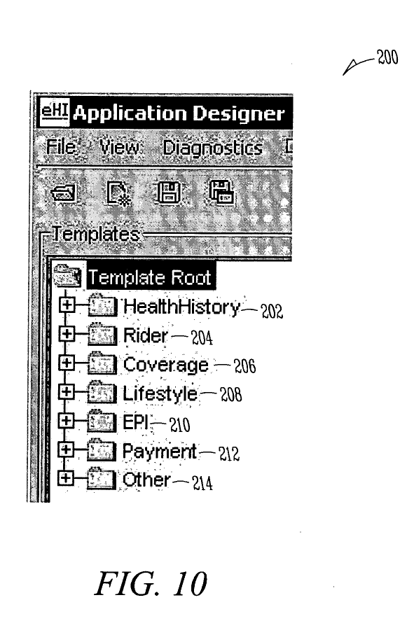

Referring to FIG. 9, reference 170 generally indicates a wizard, in accordance with an example embodiment, to assist a user in generating an application form. As shown at block 178, the wizard 170 monitors dragging and dropping of a reference page 54.1-54.n into the page layout zone 52. For example, the wizard 170 may be a health history wizard (see block 180) that may prompt and accept questions and follow-up data from the user (see block 182). Thereafter, as shown at block 184, the method 170 optionally accepts second level follow-up data from the user. At block 186, health history pages and conditional follow-up pages are inserted into the data structure. The method 170 then ends at 188. Returning to block 186, once the example health history pages have been identified, the method 170 at block 190 then updates the schema (e.g. XML schema) and screen flow models. Based on the updated schema, the application manifest and flow script file 192, page templates and rules files 194.1-194.1, and an application schema file 196 may be generated.

In an example embodiment, the system 10 allows a user to build and maintain online health insurance applications and PDF mappings conforming to an XML-based architecture. For example, the system 10 may be used to build an entire health insurance application which is rendered on-the-fly by the runtime engine 18 when an applicant fills out an online application form. A health insurance application may have one or more applicant pages, a series of pages posing health history questions and corresponding follow-up pages, pages providing coverage questions and related follow-up pages, an EPI (Electronic Processing Interface as described in pending U.S. patent application Ser. No. 10/016,302 filed Oct. 29, 2001), and other appropriate additional pages. Thus, in an example embodiment, the system 10 allows a user to create pages corresponding to different ‘buckets’ (e.g., types of pages) and specify transitions (page flow) between these pages. A page transition may occur when an applicant completing the application form submits a given page from his or her HTML browser. Thus, the actual navigation of an application form or document may be determined on-the-fly and be dependent upon specific answers or selections made by the applicant in real-time.

In an example online health insurance application form, the reference page types may include a page to obtain applicant information, a page to obtain health coverage information, a page to obtain health history information, a page to obtain health insurance rider information, and a page to obtain payment information. For example, the page to obtain applicant information may request one or more applicant names, birth date, age, height, weight, gender, marital status, relation, college-student, tobacco use, and occupation. The reference page types may also obtain address information, contact telephone number, and financial instrument details. The page to obtain health history information may request information relating previous health history of members of a health insurance plan and additional follow-up questions.

In an example embodiment, the creation of relatively complex pages, like health history questions and their follow-up pages, may be facilitated with the use of predefined templates. For example, a template may be defined by the same XML code used for defining a page of the application form (except the template may be reusable in multiple pages), along with the layout and the data definition corresponding to that section created and designed in a template library main screen, as described in more detailed below. For example in the health insurance industry standardized templates, e.g. rider plans or standard health history follow-up questions, may be available to the user in addition to user designed templates that are created and organized into categories corresponding to a health insurance providers' requirements. For example, FIG. 110 shows example template types 200 that may be displayed and provided to the user via the GUI 50 (see FIG. 3). In FIG. 110, the example template types 200 are shown for the health insurance industry and, accordingly, include a Health History template 202, a Rider template 204, a Coverage template 206, a Lifestyle template 208, an EPI template 210, a Payment template 212, or any other relevant templates 214. These templates may be reusable building blocks used by a form designer to create an application form (see FIG. 3. For example, a health history template can be used in the health history wizard (e.g., provided in block 182 in FIG. 9) to define the standard follow-up questions.

Example Application Data Structure

In an example embodiment, the system 10 organizes data into a ‘core-data’ section and a ‘non-core-data’ or ‘other-data ’ section. The core-data may correspond to the data which the system provider (e.g. an online health service aggregator) tracks across multiple applications from multiple health insurance carriers. In an example embodiment, the core-data is persisted in well-defined database table structure. The core-data may be data in an application that meets two criteria. First, the core-data may have an identical meaning in every single application (or at least a group of applications). Second, the data may be used in an aggregate fashion by a 3^{rd} party, such as a Customer Relations Management (CRM) system, or reporting system, etc. In an example embodiment, when both these criteria are met the data or information may be considered as core-data. In addition to the core-data, non-core-data or other-data may define any other-data or information that is not core-data. In an example embodiment, when the data model is defined, a core-data schema may already be defined. The other-data section may require the user to define a schema to express how that data will be modeled. This schema may be unique for a particular application. Thus, core-data may relate to multiple applications whereas non-core-data or other-data may only relate to a specific application form that is being built.

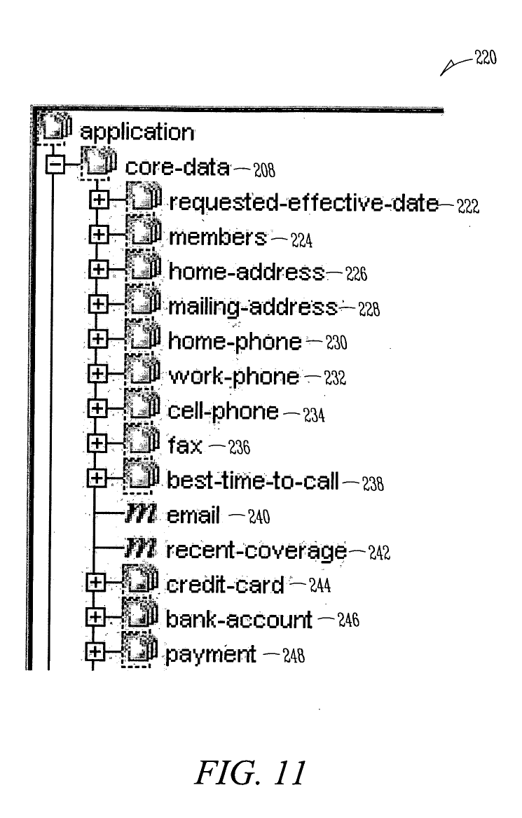

In FIG. 11, reference 220 generally indicates examples of core-data in a health insurance application form. For example, the core-data 220 may be displayed in a tree structure and made accessible to the user via the GUI 50. The core-data is shown to include requested effective date 222, details of members 224, a home address 226, a mailing address 228, a home phone number 230, a work phone number 232, a cell phone number 234, a fax number 236, a best time to call 258, an e-mail address 240, details of a recent coverage 242, details of a credit card 244, details of a bank account 246, payment details 248.

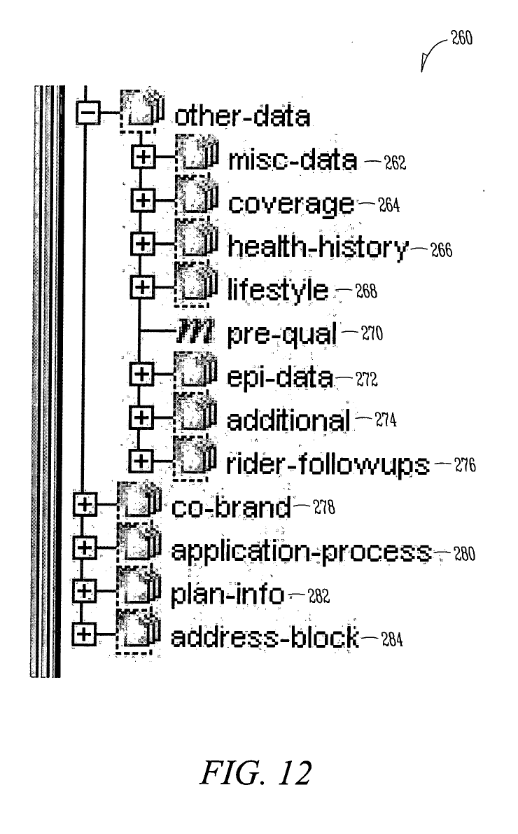

FIG. 12 generally indicates examples of non-core-data or other-data in a health insurance application form. For example, the non-core-data 260 may include miscellaneous data 262, coverage data 264, health history data 266, lifestyle data 268, pre-qualification data 270, EPI data 272, additional data 274, rider follow-up data 276, co-brand data 278, application-process data 280, plan information data 282, address block data (e.g., an additional address) 284, or the like. In an example embodiment, the system 10 allows a user to view both core-data and non-core-data as a schema tree which may represent the all data variables available for a particular application form to be built.

As described above with reference to FIG. 6, the method 110 may perform page design processing in an automated manner in response to a user's page building action. The system 10 may include a page editor module 12.6 (see FIG. 4) to allow a user to define the actual pages in response to a user dragging and dropping UI components 68.1-68.k into the page layout zone 52.

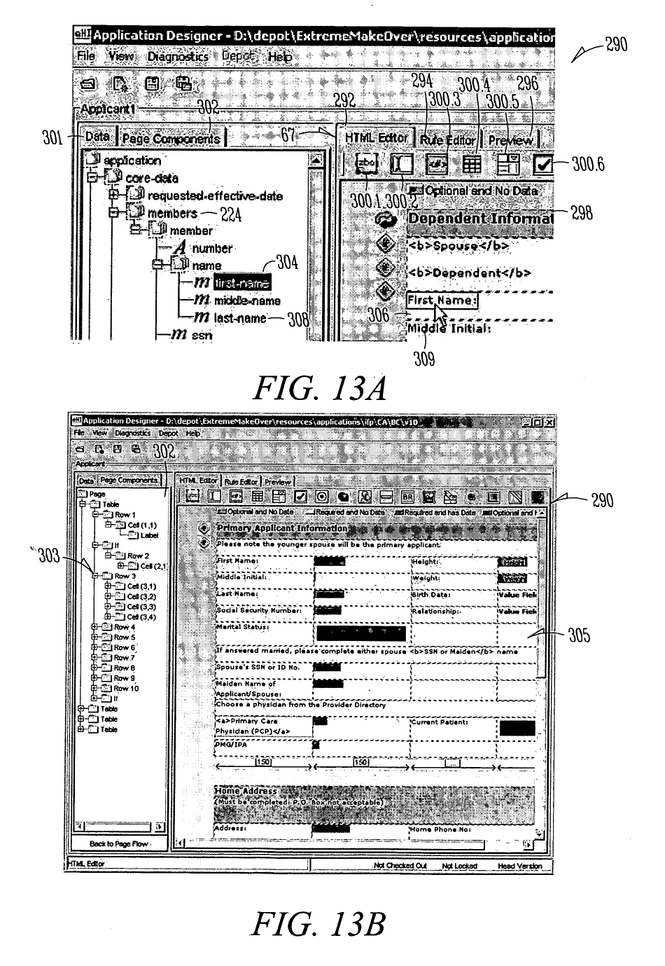

Referring in particular to FIG. 13A, reference 290 generally indicates an example graphical user interface including a UI toolbar 67 which includes an HTML editor tab 292, a rule editor tab 294 (see FIGS. 7 and 8), and a preview tab 296 that allows a user to preview a form or parts of the application form being built. In the example GUI 290 a details display area 298 is shown that corresponds to the HTML editor tab 292. Further, when the HTML editor tab 292 is selected, a plurality of UI components may be displayed, as described in more detail below. It will be appreciated that other UI components may be provided in different embodiments.

In the example GUI 290, a data tab 301 and a page components tab 302 is also provided. When the user selects the data tab 301, as shown in FIG. 13A, a tree-structured representation of the core-data and other-data associated with the form being built may be displayed. In an example embodiment, the graphical components of the designed page may be shown as rows and elements (or cells) within each row. When the user selects the page components tab 302, as shown in FIG. 13B, a tree-structured representation of the page being designed may be displayed (see arrow 303). In an example embodiment, the graphical components of the designed page may be shown as rows and elements (or cells) within each row (see arrow 305).

In the GUI 290, the user may, for example, selects details of members 224 (see also FIG. 11) which may then provide a sub-tree or subsection of data types or fields that the user may drag into the details display area 298 to build a portion of an application form page. For example, if the user has dragged and dropped details of members 224 into the details display area 298 using a computer mouse, the user may then drag some components such as a first name 304 into the details display area 298 (see sub-field 306). Likewise, the user may drag a middle name 308 into the details display area 298 (see sub-field 309). Thus, using the aforementioned methodology, the user may generally define a high level page layout of an application form as well as various portions or fields of the particular page.

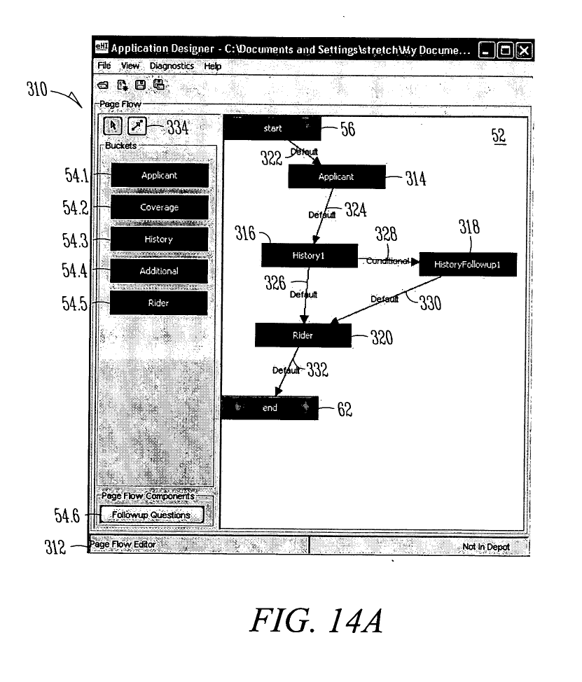

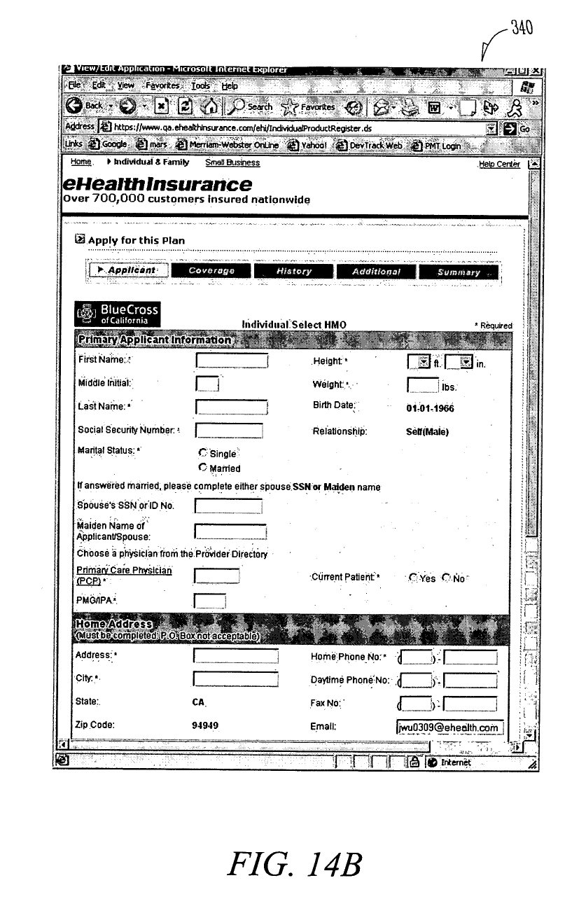

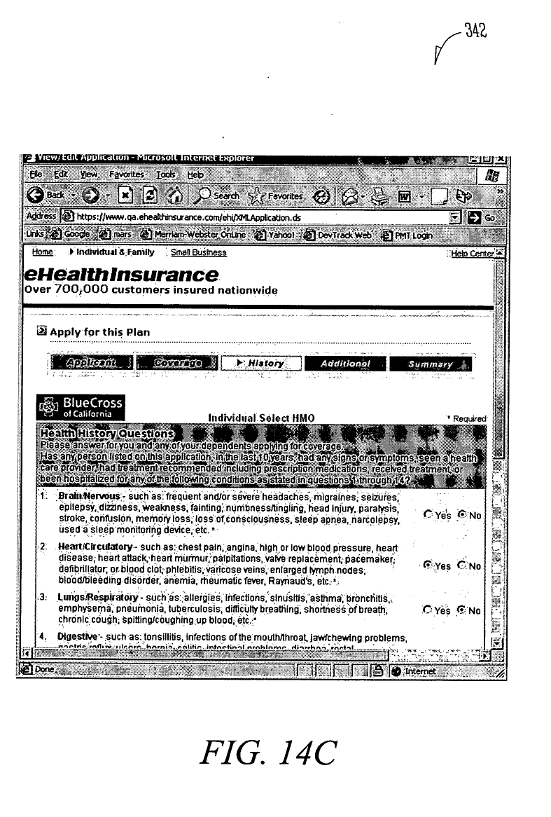

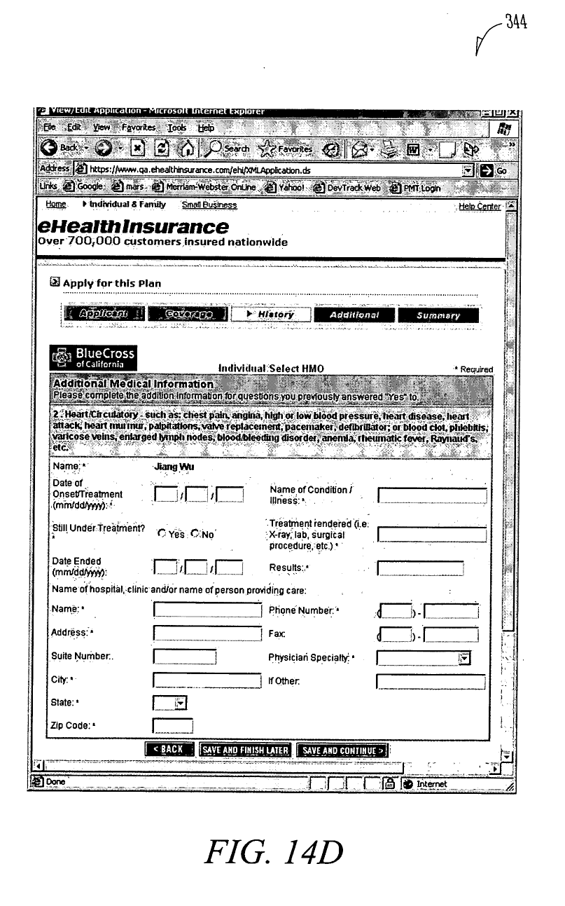

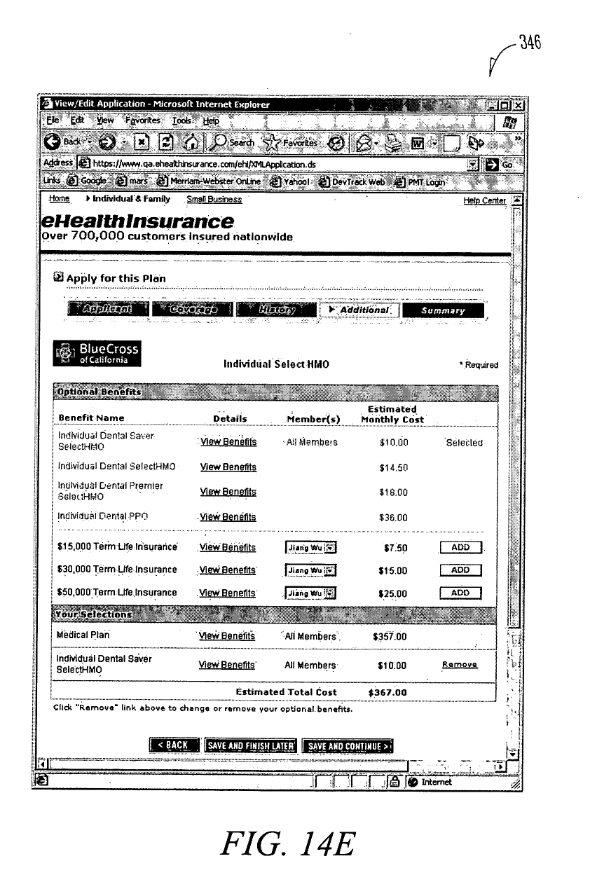

As shown in the GUI 310 (see FIG. 14A), the user may for example using the page flow editor 12.5 (see FIG. 4) define the sequence in which pages are to be presented to the user at runtime (e.g. using the runtime engine 18). In the FIG. 14A an example of page flow is shown where the user has built applicant page 314 by dragging and dropping the applicant reference page 54.1 into the page layout zone 52; has built history pages 316 and 318 by dragging and dropping the reference page 54.3 into the page layout zone 52; and has built a rider page 320 by dragging and dropping the reference page 54.5 into the page layout zone 52. It will be noted that the page transitions 322-332, and the associated database structure to implement them, is automatically generated by the system 10. Further, it will be noted that the page transitions 328 is shown to be a conditional page transition which may have been defined by the user (e.g., see block 82 in the method 70 shown in FIG. 5).

FIGS. 14B-14E show example pages that may be built and subsequently rendered to the applicant at runtime. In particular, reference 340 generally indicates an example page that may be rendered at runtime corresponding to the applicant page 314 built using the GUI 310. Reference 342 generally indicates an example page that may be rendered at runtime corresponding to the medical history page 316, and reference 344 generally indicates an example page that may correspond to the history follow-up page 318. An example page corresponding to the rider page 320 is generally indicated by 346.

In the example embodiment shown in FIG. 13 and FIG. 14A the GUI to define a page layout and the actual pages are shown to be separate GUIs. For example FIG. 14A shows an example GUI to define the page flow and FIG. 13 shows a GUI to define the page structure, e.g., of a single page of the application form. It is however to be appreciated that this functionality (and any other functionality) may be combined in a single GUI or provided in several GUIs.

Example Pre-Qualification ‘Start’ Bucket Configuration Page

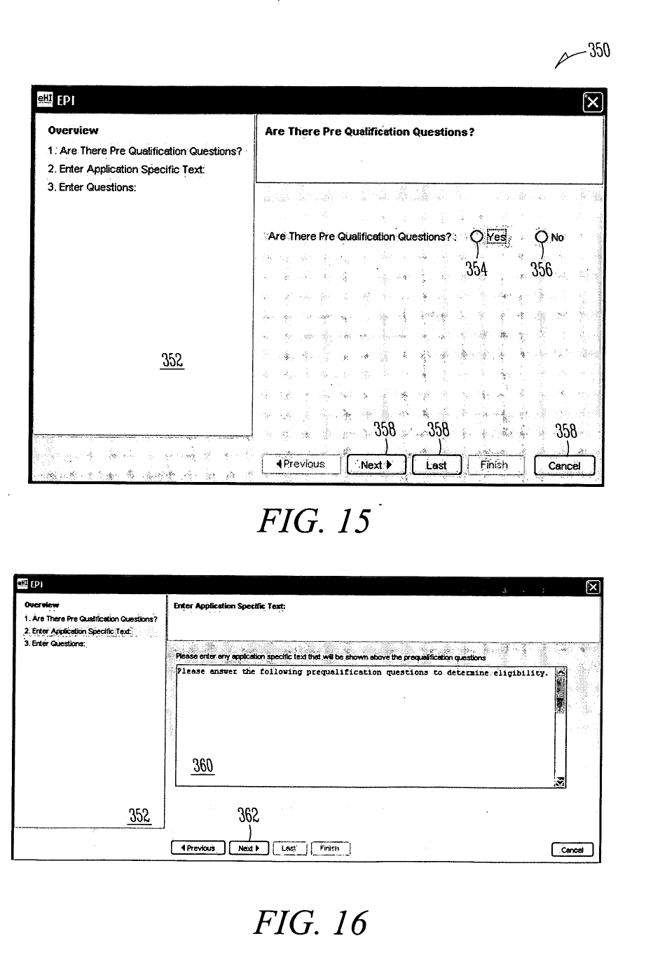

As shown by way of example in FIGS. 3 and 14A, an initial start node 56 may be provided. The initial start node 56 may determine if there are any pre-qualification questions and allow the user to define application-specific text. In order to accomplish this, in an example embodiment a user may right click on the initial start node 56 which then provides a pop-up menu where the user may select ‘Configure Pre-Qualification Screens’ option. In response to the selection, a GUI 350 (see FIG. 15) may be presented to the user. The GUI 350 is shown, by way of example, to include an overview pane 352 which provides an ‘Are there are pre-qualification questions?’ option. The user may then check an appropriate checkbox 354 (‘Yes’) or 356 (‘No’). Navigation buttons 358 allowed the user to navigate appropriately. Thus, assuming the user selects the ‘Yes’ checkbox 354, he or she may then activate the ‘Next’ navigation button 358. A text entry box 360 may then be provided (see FIG. 16) and the user may then enter the text that is to be displayed as a pre-qualification question to an applicant completing the application form.

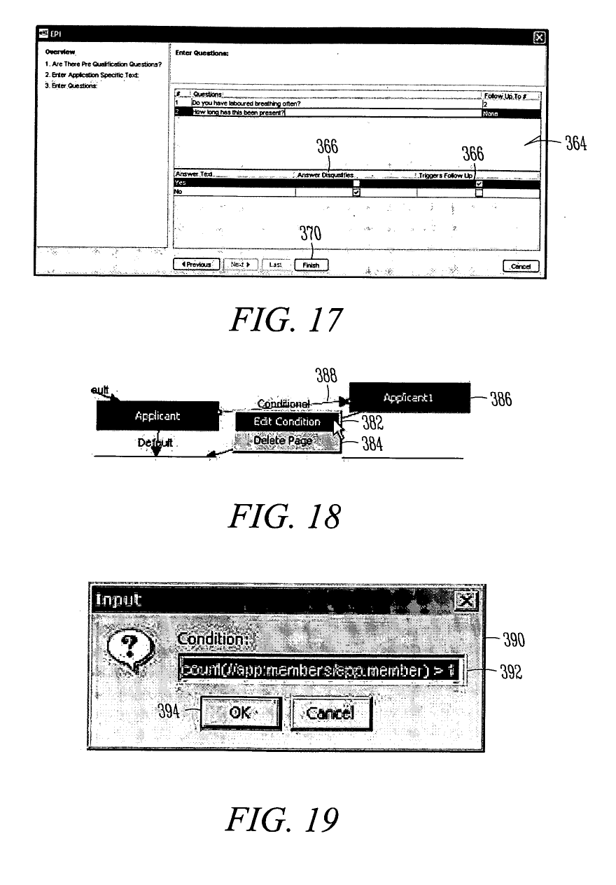

After the user has activated the next button 362, a text entry box 364 (see FIG. 17) may be provided in the GUI 350 where the user may enter questions and corresponding answers that may be selected by the applicant. It will be noted that the user may define consequences to specific answers. For example, a shown at 366, the user may in the application form being built provide a business rule that disqualifies the applicant if a particular answer is selected. As shown at 368, the user may also define triggers that result in follow-up questions that may be presented to the applicant in response to a particular answer. Building of the pre-qualification questions may be terminated when the user activates a ‘Finish’ button 370. Thus, in an example health-insurance online application form the user may define pre-qualification questions that determine the eligibility of a potential applicant and, in response to the questions, may terminate the application procedure or continue therewith.

Example Applicant ‘Bucket’ Configuration Page

In an example embodiment, an applicant bucket (e.g., see reference page 54.1 in FIG. 14A) may allow the user or form builder to define personal data fields of potential insured individuals. It will however be appreciated that, for a particular industry in which the system 10 is to be deployed, templates may be designed for one or more of the reference pages 54.1-54.6. However, one or more of the reference pages 51.4-54.6 may be created by the user during a form building process. In an example embodiment where the system 10 is deployed in a health-insurance environment, the user may right click on the page type zone 54 and select an option to create a new template based on, for example, a hard copy of a particular health-insurance carrier application form (e.g. PDF application form). As described above, in an example embodiment, a wizard may automatically be invoked in order to assist the user in creating a new template. If, however, the user chooses to select an existing reference page 54.1-54.n, the user may merely drag-and-drop a selected page into the page layout zone 52 and the page is automatically included in the application form being built. Further, it will be appreciated that multiple applicants (e.g., multiple family members) may be associated with a single application form. Accordingly, the user may drag-and-drop the reference applicant page 54.1 into the page layout zone 52 several times depending on the number of applicants the online application form should accommodate. It is however also be appreciated that the runtime engine 18 may not necessarily render all the application pages or screens to a potential applicant. In an example embodiment, the runtime engine 18 may automatically determines, based on input from a potential applicant, which pages are to be rendered and provided to a potential applicant during completion of the application form. It will be appreciated that the form builder may not only add application pages but also modify and delete application pages from the application page flow.

Example Creation of Conditional Connections Between Pages/Screens

In an example embodiment a conditional connect/transition button 334 (see FIG. 14A) may be provided to allow the user to define conditional connections or page transitions. In an example embodiment, the user may select the conditional connect button 334 and draw a conditional connect transition line between two nodes or application pages in the page layout zone 52 (see conditional transition 328 in FIG. 14A). The user may then right click on the page transition line connecting the two application pages which then invokes a pop-up menu to define the conditional transition. Example choices provided in the pop-up menu include an ‘Edit Condition’ option 382 and a ‘Delete Page’ option 384 (see FIG. 18). If, for example, the user selects the Delete Page option 384 then the page 386 and the conditional transition 388 may be deleted. If, however, the user selects the Edit condition option 382 a pop-up window at 390 (see FIG. 19) may be provided to allow the user to customize the particular page transition. For example, the user may determine if a count of the number of members associated with the application form exceeds any predetermined number (e.g., ‘1’ as shown in FIG. 19). Once the user has defined the page transition (see path 392) he or she may activate an ‘Okay’ button 394. In an example embodiment, the pop-up window 390 allows a user to choose one of a plurality of reference XML string scheme or XPath expressions (e.g., count(//app:members/app:member)>1) which may be recognized by a descriptive name.

Example Template Library

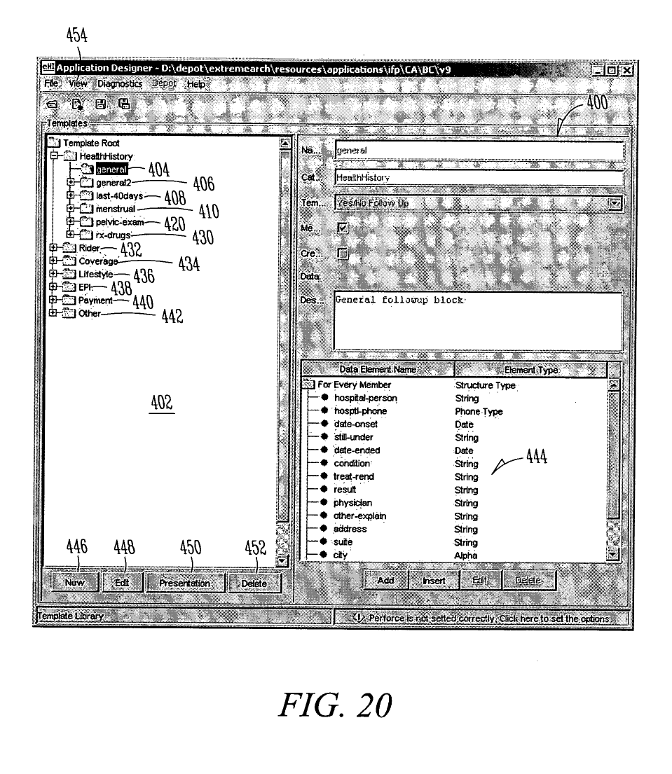

FIG. 20 shows an example GUI 400 of a template library window, in accordance with an example embodiment when the system 10 is used to generate health insurance application forms. The template library window may be navigated to via the ‘View’ functionality provided in the toolbar. The template library interface window may include a plurality of predefined templates 402 that are customized for a particular industry. The predefined templates 402 are shown, by way of example, to be customized for the health insurance industry and include various templates relating to a potential applicant's health history. For example, the predefined templates 402 may include a first general template 404, a second general template 406, a last 40 days template 408, a menstrual template 410, a pelvic examination template 420, a prescription drugs template 430, or any other relevant templates that may relate to the health history of a potential applicant. Further, a rider template 432, a coverage template 434, a lifestyle template 436, an EPI template 438, a payment template 440, or any other templates 442 may be provided. It will be appreciated that the templates may be customized to particular application or context in which the system 10 is to be used.

As shown by in display zone 444, various data elements may be provided to allow the user to build a customized form. It will be noted that the example data elements shown in FIG. 20 correspond to data elements used in an example health insurance application form. In an example embodiment, before a user creates the example applicant page 54.1, the coverage page 54.2, the history page 54.3, any additional pages 54.4, the rider page 54.5, or the other questions page 54.6 (see FIG. 14A), the user may be required to determine or select relevant templates for these pages from a hardcopy/original of the insurance carrier's application form.

Any one or more templates 402 may include sub-sections or sub-directories that can be used to automatically generate fields in the application form. For example, when the user selects the first general template 404, associated data elements may be displayed in the display zone 444.

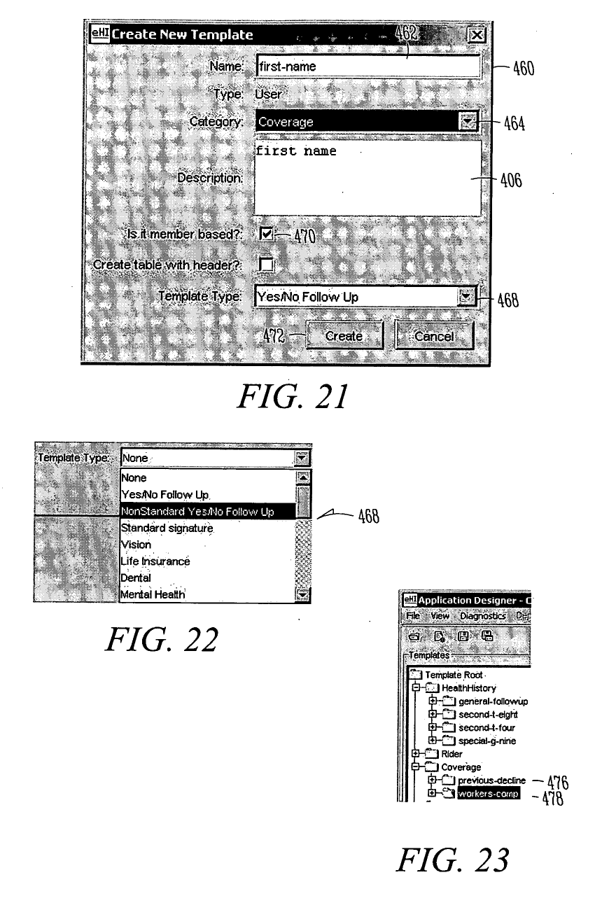

The GUI 400 is also shown to include a ‘New’ button 446, an ‘Edit’ button 448, a ‘Presentation’ button 450, and a ‘Delete’ button 452. In use, a user may select the template GUI 400 from a ‘View’ menu 454 and highlight a particular template 402 and, thereafter, click the ‘New’ button 446 to generate a new template. In response thereto, a pop-up window 460 (see FIG. 21) may be generated that includes a field 462 to define a name of the template, a category of the template 464 (e.g. a coverage template), a field 466 to provide a description of the new template, as well as a drop-down menu 468 to define the type of the new template. Various check boxes may also be provided to allow the user to define the template in more detail. For example, a member-based checkbox 470 may be provided if multiple members (e.g., a spouse, dependents, or the like) may be accommodated. FIG. 22 shows an example detail of the drop-down menu 468. The example drop-down menu 468 is shown to be customized for the health-insurance industry and, accordingly, includes a vision template, a life-insurance template, a dental template, and a mental health template.

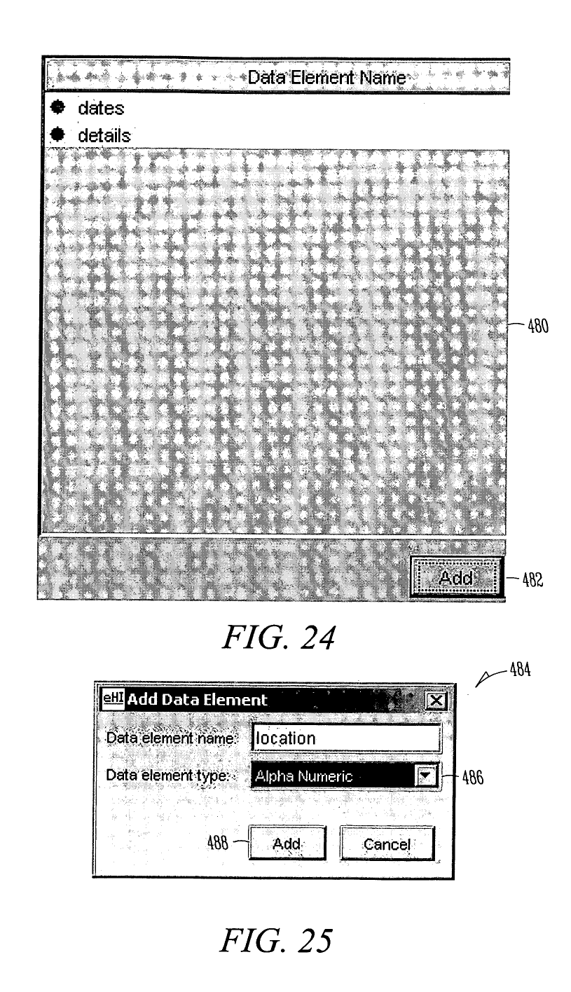

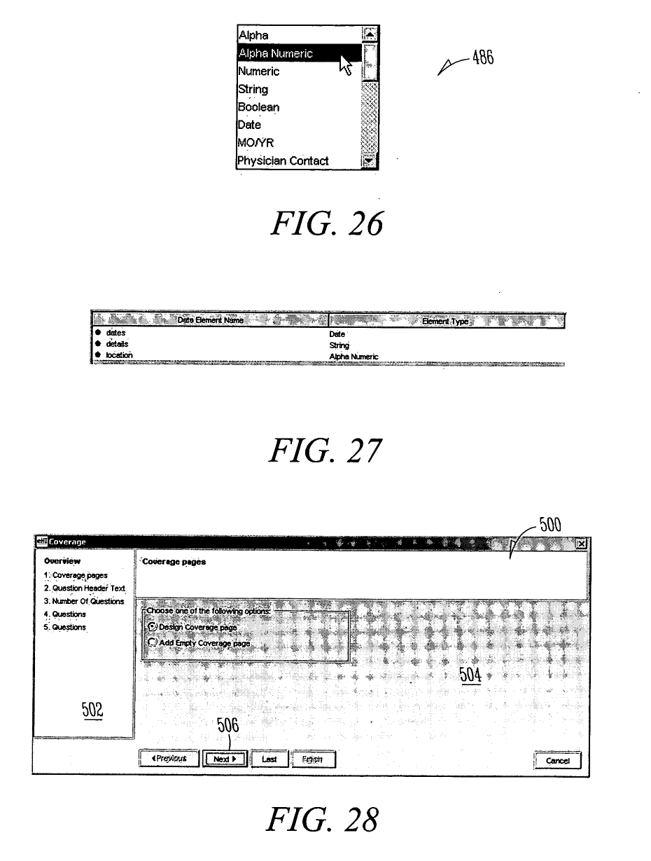

Once a particular template type has been chosen from the drop-down menu 468, the user may be required to activate a ‘Create’ button 472. Thereafter, the user is then required to create data elements associated with the new template. Data elements and their associated types may be used to populate the template and thus define the content of the template. FIG. 23 shows example sub-sections or sub-directories of the coverage template 434 (see FIG. 20). For example, the coverage template 434 may include a previous decline template 474, and a workers compensation template 476 which, when presented to the applicant, requests relevant information from the applicant. Thus, a builder of an application form may merely select a template and system 10 then automatically generates the required data structure for displaying relevant questions and receiving associated answers from the potential applicant. FIGS. 24-27 show example data element pop-up windows that allow the user to add data elements to a template. A pop-up window 480 (see FIG. 24) allows the user to enter the name a new and data element. For example, in the example window 480 the user may name the new data element as a ‘Dates’ element or a ‘Details’ element. A user may then select one or more of the data element names and thereafter activate an ‘Add’ button 482 to add the data elements to the template. Thereafter, a pop-up window 484 (see FIG. 25) may be provided to allow the user to define a data element type using a drop-down menu 486. Once the user has selected a particular data element type from the drop-down menu 486 (see FIG. 26), the user may then activate an ‘Add’ button 488 to replace a new data type under a last data element entered for the template being defined. FIG. 27 shows example data elements that the user has added to the template being built or defined.

Example Wizard

In an example embodiment, a wizard (see block 76 in FIG. 5 and wizard module 12.7 in FIG. 4) of may be provided that generates industry related questions which are presented to the user via a GUI or series of GUIs. Answers to the industry based questions provided by the user are utilized to automatically generate a data structure which, at runtime, generates application forms that may be provided to the potential applicant via, for example, a Web browser. As discussed above, the user can create follow-up and conditional pages using the wizard and the pages may correspond to sections of an unalterable application form (e.g., the sections may correspond to sections of a PDF copy of an application form). For example, the health history questions may ask an applicant “Have you ever had heart problems?” Based on a user designed response, a ‘Yes’ selection by a potential applicant during runtime could trigger a follow-up question asking ‘What kinds of heart problems?’ The questions and follow-up questions may be designed or built by the user during the form building process with the aid of the wizard 12.7 and the method 170.

For example, when a user drags the coverage reference page 54.2, the history reference page 54.3, the additional reference page 54.4, and/or the rider reference page 54.5 (see FIG. 14A) into the page layout zone 52, an initial wizard GUI 500 may be displayed (see FIG. 28). The wizard GUIs may comprise a plurality of sequential screens that are presented to the user (e.g., see FIGS. 28 to 31). The initial wizard GUI 500 may include an overview pane 502 and an options pane 504. As shown in the overview pane 502, the wizard 12.7 may allow a user to define cover pages, question header text, a number of questions to be accommodated by the application form, and the specific questions to be inserted in the form being built. Further, in the options pane 504, the user may choose a Designed Coverage page option or an Add Empty Coverage page option. Thereafter, the user may select a ‘Next’ button 506 to proceed with further assistance from the wizard.

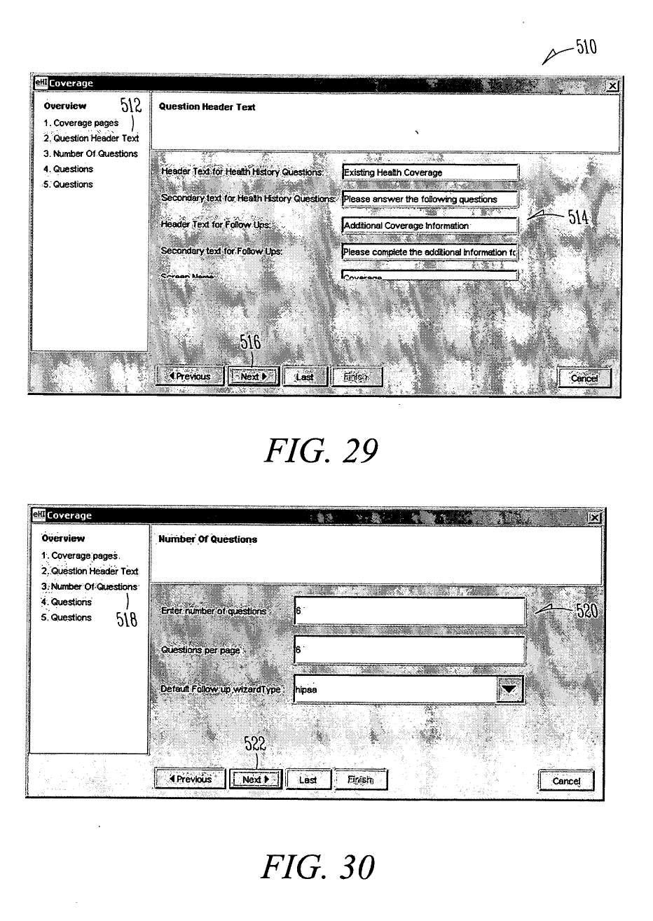

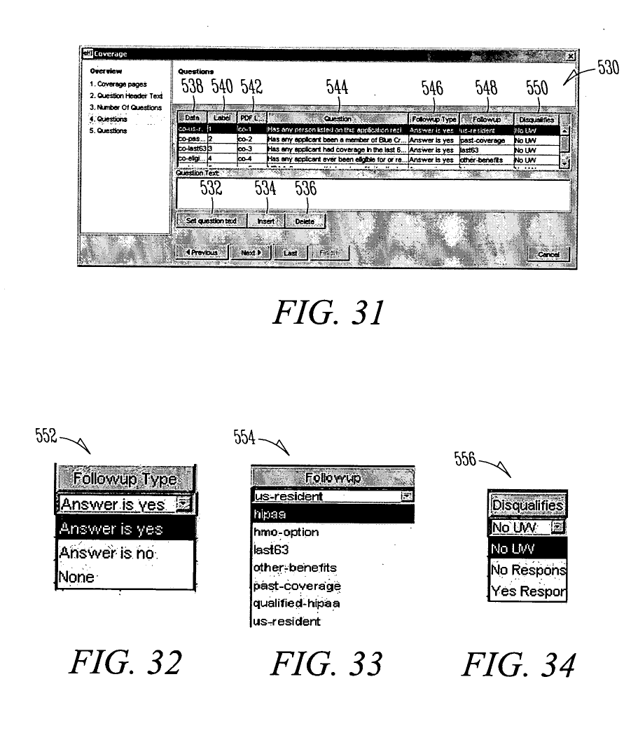

FIG. 29 shows an example question GUI 510 of the wizard which is displayed as the wizard progresses through a sequence of screens (e.g., a ‘Question Header Text’ 512 in the overview pane 502). As can be seen in FIG. 29, the user may then define various questions 514 to be included in the application form. After the user has defined the various questions 514, the user may activate a ‘Next’ button 516. When a ‘Number of Questions’ 518 is selected (see FIG. 30), further fields 520 are displayed that, for example, allow the user to enter a number of questions to be presented add runtime, the number of questions per page, as well as whether or not an (optional) default follow-up the wizard is required. Once the user has completed the fields 520, a ‘Next’ button 522 may be activated. In certain embodiments, and optional wizard follow-up GUI 530 is provided that allows a user to control how questions are entered into a questions text field (see the various questions 514 in FIG. 29), show which question is a follow-up type, identify a particular follow-up question, and identify if a particular response to the question disqualifies the potential applicant (see FIG. 31). Although the questions in the follow-up GUI 530 are shown to be related to the health insurance industry, it will be appreciated that in other applications different questions may be provided by the wizard. Buttons 532, 534 and 536 allow the user to set question text, insert question text, and delete question text.

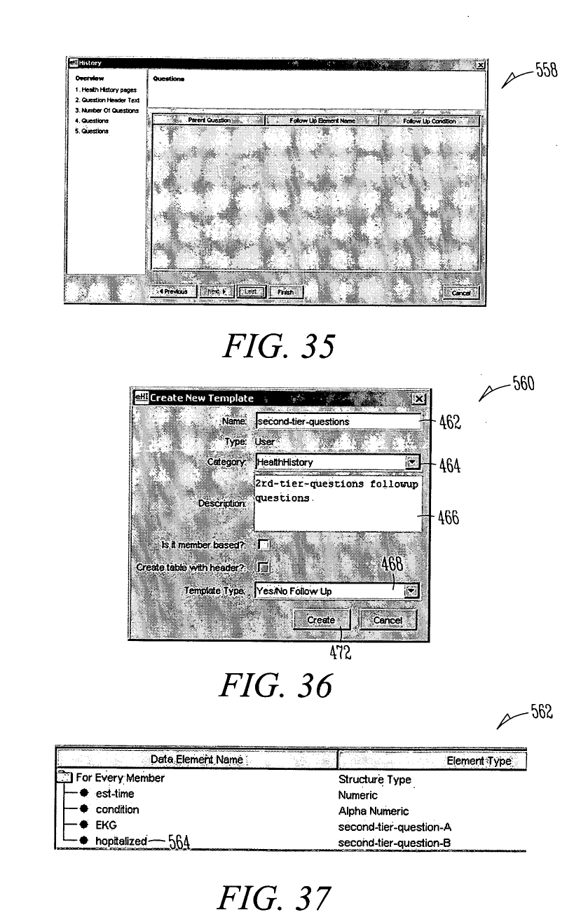

In an example embodiment, a ‘Data’ heading 538, ‘Label’ heading 540, a ‘PDF label’ heading, a ‘Question’ heading 544, a ‘Follow-up Type’ heading 546, a ‘Follow-up’ heading 548, and ‘Disqualifies’ heading 550 may be provided. For example, when a particular row is highlighted, the user may right click on a cell under the Follow-up Type heading 546 and, using a drop-down menu 552 (see FIG. 32), identify in the form whether a sequence of follow-up questions should be triggered by a ‘yes’ or a‘no’ response from the potential applicant (or no user response at all). Likewise, when the user right clicks on a cell under the Follow-up heading 548 and, using a drop-down menu 554, the user may select the nature of the follow-up questions (see FIG. 33). FIG. 44 shows an example drop-down menu 556 that allows the user to select what response by an applicant will disqualify the applicant. Should a second-tier of follow-up questions be required, the wizard may provide a second-tier follow up wizard GUI 558 (see FIG. 35) to assist the user in building a second-tier of follow-up questions.

Example Coverage Reference Page or Bucket

The coverage reference page (e.g., the coverage reference page 54.2 shown in FIG. 14A) may include personal data field of potential insured individuals. In an example embodiment, prior to the user dragging and dropping the coverage reference page 54.2 into the page layouts and 52, the user may be required to define a coverage reference page template as hearing before described. For example, the coverage reference page template may be based on the relevant sections of a hard copy of an application form provided by health insurance carriers. Further, in an example embodiment, a wizard that generates a set sequence of questions may be used to generate the appropriate template.

Example Health History Reference Page or Bucket

As shown in FIG. 14A, in an example embodiment a history reference page 54.3 may be provided when the system 10 is deployed in the health insurance industry. Health History pages may contain historical applicant medical-related questions that may trigger the design of one or more ‘HistoryFollowup’ application page or bucket. It will be appreciated that the page design may be dependant on the particular medical-related questions included in the application form being built. In an example embodiment, the actual questions presented to the potential applicant by the runtime engine 18 may be dependant upon answers given by the potential applicant to the questions he or she is presented with. It will also be appreciated that, the number of ‘HistoryFollowup’ questions, and ‘HistorySubFollowup’ questions presented to the applicant in one or more pages may be dependant upon the actual online application form being built. For example, a particular health insurance carrier may require a substantial number of medical history questions and, accordingly, when building an application form multiple questions and sub-questions pages or buckets may be required.

In an example embodiment, in order to build application form pages addressing health history questions, the form builder or user may drag and drop the history reference page 54.3 into the page layout zone 52 as shown at the history page 316 in FIG. 14A. In an example embodiment, this action automatically invokes the page wizard that helps the user to create question and follow-up pages along with appropriate page transitions. The user may then right click on the history page 316 and a pop-up window may be provided for the user to customize the page being built as described, for example, above with reference to the applicant page 314.

The system 10 may require a pre-existing template to perform this functionality. The pre-existing template may be created or built as described above. When the system 10 is deployed to create online application forms in the health insurance industry, the template(s) may be built from a hardcopy/PDF of a health insurance carrier's application forms.

When a history follow-up page 318 (see FIG. 14A) is dragged and dropped into the page layout zone 52, a default page transitions 328 may initially be created and the user may then subsequently edit or modify the page transition (see for example FIGS. 18 and 19). It will be appreciated that any number of follow pages may be created. The number of follow-up pages may be dependant upon the complexity and number of questions of online application form being built. An example path 392 (see FIG. 19) associated with the page transition for a health history page question may be provided by the following Xpath expression:

//app:other-data/app:health-history/app:hh-5/app:blood-pressure/@answer = ‘Y’ or
//app:other-data/app:health-history/app:hh-5/app:ekg/@answer = ‘Y’

In an example embodiment, a plurality of Xpath expressions may be provided as predefined conditions.

The system 10 may allow user to create second-tier of follow-up questions that are customized to a particular industry, for example, customized to health insurance application forms. For example, a first-tier question in the form being built may ask a potential applicant ‘Have you been diagnosed with hypertension and high blood-pressure?’ If the applicant responds during runtime by clicking a ‘No’ checkbox, the runtime engine 18 may then move on to the next page of the flow. However, if the potential applicant clicks a ‘Yes’ checkbox, a second-tier or follow question may then be presented to the potential applicant. An example second-tier question that may then be built by the user utilizing the example graphical user interfaces shown in FIGS. 36-42.

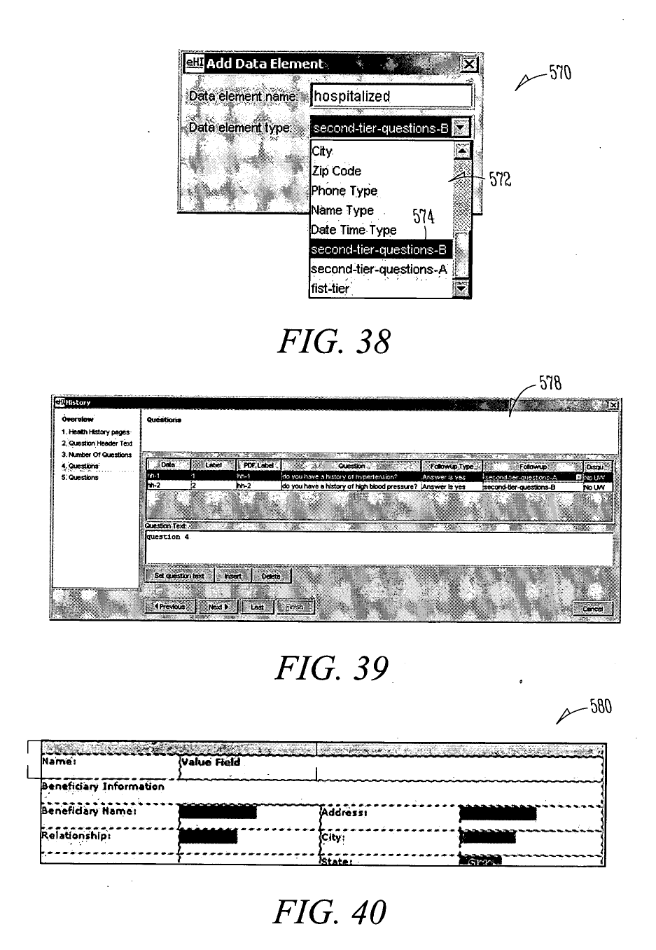

In an example embodiment, in order to create a new template, the user may select the template library main screen (see the GUI 400 shown in FIG. 20) and activate the ‘New’ button 446 to define a new template, as described above. Data entered by the user into the various fields of a pop-up window 560 (see FIG. 36) is used to create a follow-up or second-tier template. The follow-up may differ from that required to define or create a first-tier template. For example, in order to create a follow-up template for health history questions, the user selects the ‘HealthHistory’ option from the drop-down menu 464 (see FIG. 36) and, as a shown in a pop-up window 562 (see FIG. 37), data element type associations may be defined for the follow-up template. Assuming for example that the user selects the ‘hospitalized’ data element 564, then a pop-up window 570 (see FIG. 38) may be provided. The pop-up window 570 includes an example drop-down menu 572 that allows a user to select first-tier and second-tier template types. Assuming the user selects a second-tier-questions-B option 574, the template created can be used in the health history wizard in the example pop-up window 578 shown in FIG. 39. Using the example pop-up window 578 the user may then define the follow-up questions. In an example embodiment, when a presentation for a second-tier question is being built, a name of any individual associated with the health history question may be required. That may be accomplished by using existing or predefined templates as herein described. FIG. 40 shows an example component 580 that may be used in the page design.

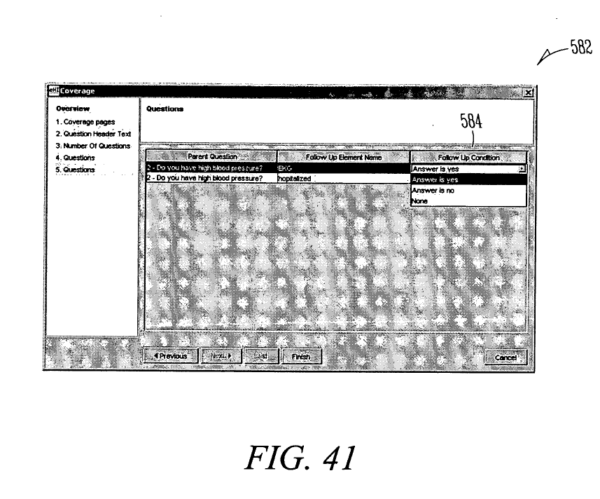

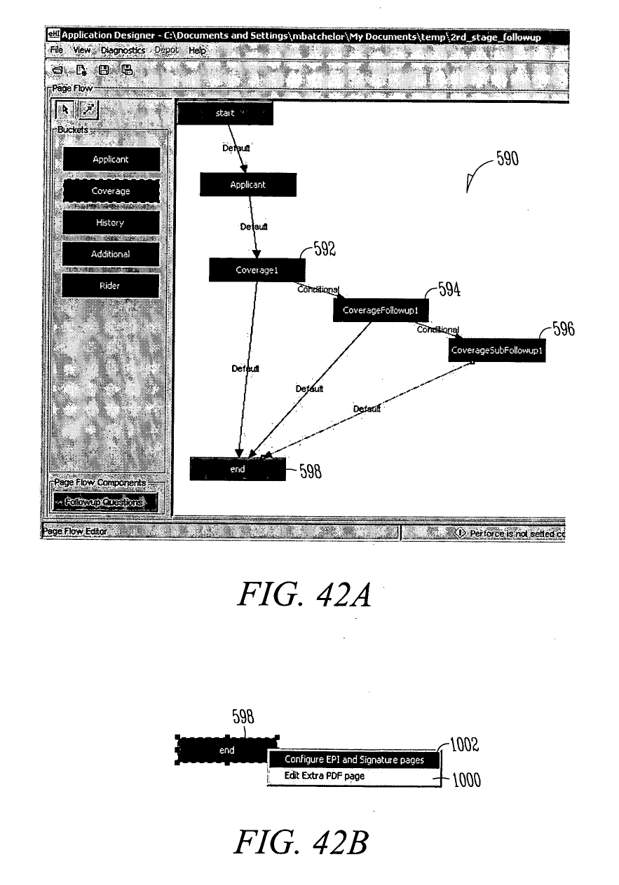

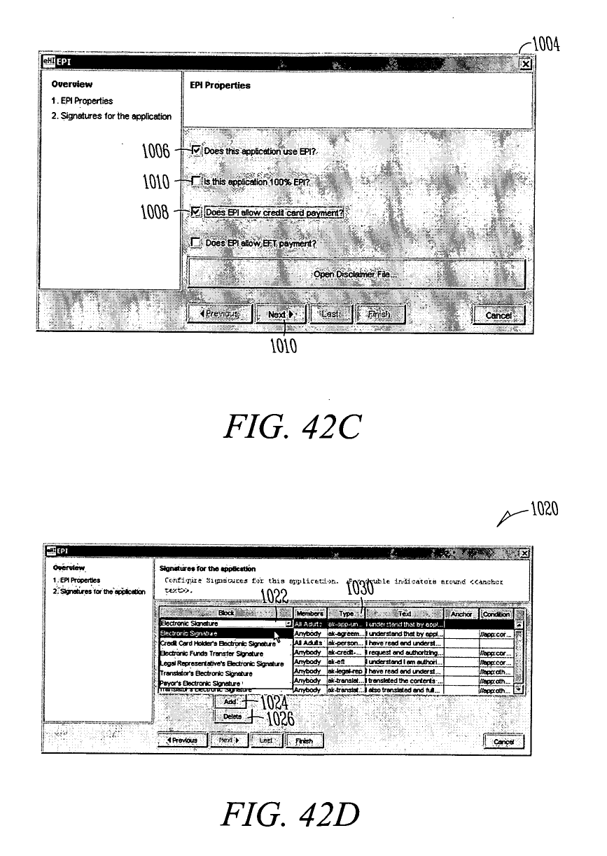

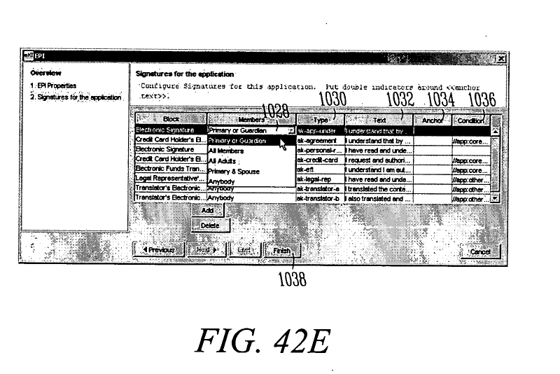

In an example embodiment, once a first-tier question has been defined the user is then required to state the condition that will trigger an associated second-tier follow-up page. Only questions that were associated with a second-tier follow-ups may be displayed. Following on the ‘HealthHistory’ example, the question ‘Do you have high blood-pressure?’ may result in a follow-up element name ‘EKG’ and the user may then define the answer required to proceed to the follow question. As shown in FIG. 41, a GUI 582 may be provided with a follow-up drop-down menu 584 to allow the user to select an appropriate answer required from the potential applicant to proceed with the follow-up question. An example the GUI 590 showing multiple follow questions is shown in FIG. 42A. In the example GUI 590 a coverage page 592 may include a series of questions and, dependant upon the potential applicant's response to the questions, a coverage follow-up page 594 may be presented to the potential applicant. Thereafter, one or more questions may be provided in a coverage follow-up page 594 and, dependant upon a potential applicant's response to a question, a next level coverage follow-up page 596 may be presented to the potential applicant.

Example Building Rider Page

In an example embodiment, when the user the drags and drops the rider reference page 54.5 into the page layout zone 52 (see FIG. 14A), a rider page may be constructed for the particular application form that is being built. An example of riders in a health insurance application form include the addition of dental insurance and differing levels of life insurance coverage. In an example embodiment, a rider template is required in order to allow the aforementioned drag and drop functionality. As in the case of the other pages, the wizard 12.7 may assist the user in creating a series of questions and potential follow-up pages and the associated page transitions. In an example embodiment, a similar methodology is used to create additional reference pages 54.4.

Example Electronic Processing Interface (EPI) Functionality

As shown by way of example in FIG. 42A, an end node 598 may be provided to allow a user to complete the form building process. In response to clicking on the end node 598 an EPI wizard may automatically be invoked that builds an EPI and an eSign (EPI and Signature) page at the conclusion of the application process (e.g., completion of an application document generated by the runtime engine).

In an example embodiment, the user or form builder may, merely by way of example, right click on the end node 598 and a pop-up window 1000 (see FIG. 42B) may be provided. Thereafter, the user may select a ‘Configure EPI and Signature pages’ option 1002 which may then generate a further pop-up window 1004 (see FIG. 42C). The pop-up window 1004 provides and “Overview” including “EPI properties” and “Signature for the application” functionality. When the “EPI Properties” is displayed, a first checkbox 1006 is shown to be associated with the question ‘Does this application use EPI?’ and, when configuring EPI pages this checkbox may be checked.

If appropriate, a credit card select the checkbox 1008 may be checked that asks the question ‘Does EPI allow credit card payment?’ In an example embodiment, when checking the checkbox 1006 associated with the question ‘Does this application use EPI?’, both credit card and an Electronic Funds Transfer (EFT) payment options can be selected for an esign payment. Selecting a checkbox 1010 associated with the question ‘Is this application 100% EPI?’ may grey out credit card and EFT payments. In addition, some carriers may not require a payment page for 100% EPI and, accordingly, no payment type may be permitted for eSign. Thus, a mailed payment may be required. Upon completion/confirmation of the properties, the user may click on a “Next” button 1010 and, in response thereto, a pop-up window 1020 may be generated.

The example pop-up window 1020 allows a user or form builder to define or configure various different electronic signature block which may be presented to the applicant at runtime. The pop-up 1020 shows a plurality of electronic signature blocks that have already been created. It will however be appreciated that the pop-up window 1020 may be used to create a single signature or any number of signatures that may be presented to the applicant at runtime.

In order to create a signature, the user may click on a drop down menu 1022 which may then provide a number of signature options. In an example embodiment, the following signature options may be provided:

Electronic Signature:
Electronic signature that groups acknowledgement for members signing the application

Credit Card Holder's Electronic Signature:
A credit card's electronic signature.

Electronic Funds Transfer Signature:
An electronic signature for a EFT protocol.

Legal Representative's Electronic Signature:
An electronic signature of a legal representative.

Translator's Electronic Signature:
An electronic signature or a designated translator.

Payer's Electronic Signature:
An electronic signature attached to a designated payee of an applicant.

Electronic signatures may be added or deleted by the form builder using an “Add” button 1024 and a “Delete” button 1026.

A ‘Members’ drop down menu 1028 (see FIG. 42E) may be activated and the required member(s) for the EPI signature may be selected. Example member types include:

Primary or Guardian:
Main Applicant or legal guardian.

All Members:
Any policy member.

All Adults:
Any legal adult

Primary & Spouse:
Main applicant and legal spouse

Anybody:
Any name on the policy

Thereafter, the user may click on the EPI ‘Types’ field 1030 and a pop-up window 1032 is then provided to allow the user to make an appropriate selection (see FIG. 42E). In a similar fashion, the user may, for example, double-click a cell under a ‘Text’ column 1032 and enter ‘Acknowledgement’ content that may be displayed to an applicant at runtime. The text or content included may be dependent upon the particular signature being created. For example text associated with signing the actual application document may differ from text that is associated with an electronic signature associated with a credit card payment.

An “Anchor” column 1034 may be provided to allow the user to add, for example, standard legal text that may be associated with a particular type of electronic signature being created. This text may be pre-defined and stored in storage media. Likewise, using a condition column 1036 various conditions may be added to the electronic signature being created. Upon completion of the electronic signature, the user may click on a “Finish” button.

Example UI Component Functionality

As described above with reference to FIG. 13, the HTML editor tab 292 allows the user to drag-and-drop UI components 300.1-300.6 into the page layout zone 52 and the system 10, in an automated fashion, automatically creates an appropriate data structure for the selected a UI component.

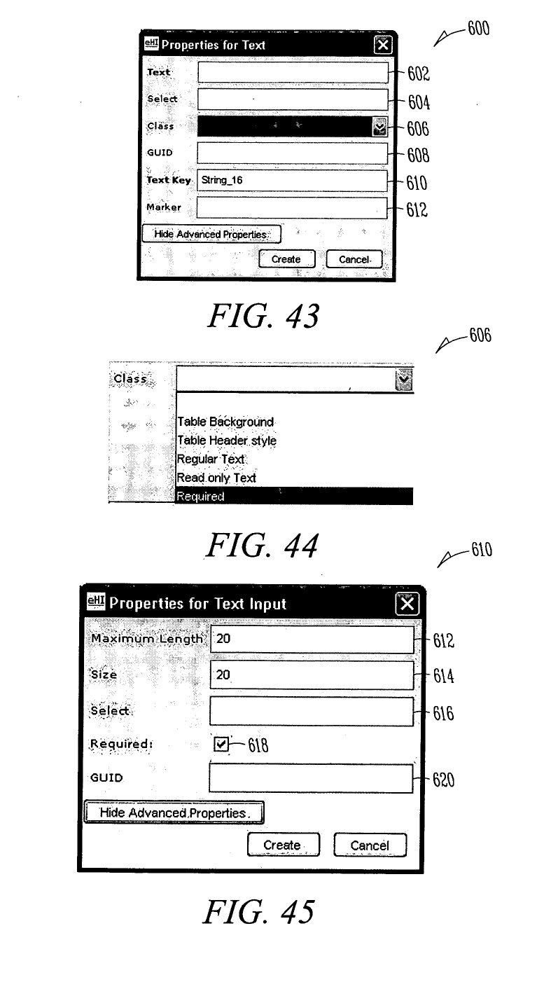

In an example embodiment, the UI component 300.1 may be an ‘Add Label’ component and selection thereof may generated a pop-up window 600 (see FIG. 43). The pop-up window 600 may allow the user to define or customize properties and, accordingly, the pop-up one window 600 includes a Text field 602, a Select field 604, a Class drop-down menu 606, a GUID (Globally Unique Identifier) field 608, a text string 610, and a Marker field 612. Text entered into the Text field 602 then define the text displayed on to a potential applicant, the Select field 604 may be used to identify an Xpath schema path, the Class drop-down menu 606 may allow the user to define a cascading style sheet, and so on.

In an example embodiment, the Select the field 604 may store the data with two purposes. First, the Select field 604 may associated data with the XML storing scheme (XPath). Second, the Select field 604 may be related to HTML display items. FIG. 44 shows the example Class drop-down menu 606 where the user may select predefined cascading style sheet attributes.

Returning to FIG. 13, UI component 300.2 may allow a user to add a text input field. When the user selects the UI component 300.2 a pop-up window 610 (see FIG. 45) may be provided. The pop-up window 610 allows the user to define various properties of the text to be input into the form that is being built. For example, a ‘Maximum Length’ field 612, a ‘Size’ field 614, a ‘Select’ field 616, a ‘Required’ checkbox 618, and a ‘GUID’ field 620 may be provided. The ‘Maximum Length’ field 612 may define the amount of characters for a text input field and the ‘Size’ field 614 may define a size of the text input field.

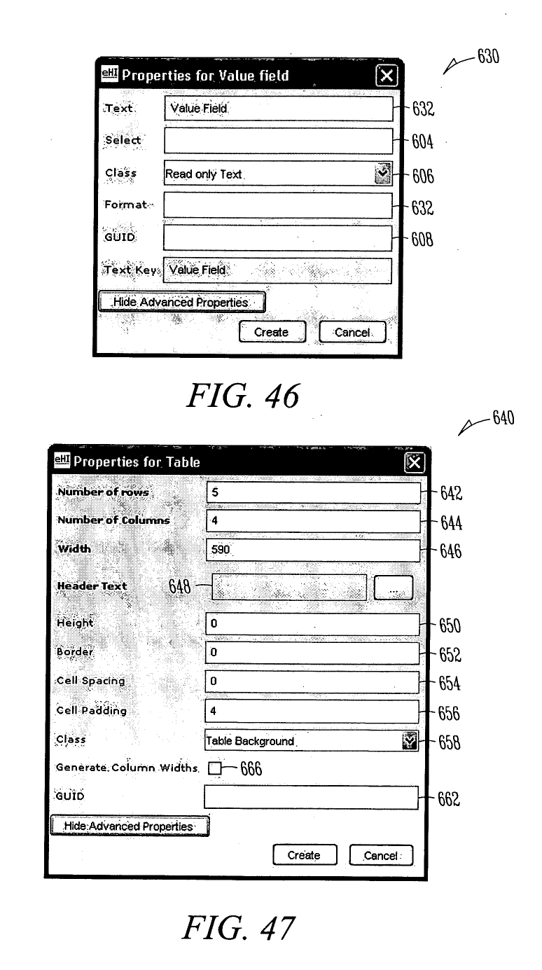

In an example embodiment, the UI component 300.3 corresponds to an ‘Add Value’ field. When the user activates the UI component 300.3, a pop-up window 630 (see FIG. 46) may be displayed. The pop-up window 630 allows the user to define various properties for a value field and it will be noted that the pop-up window 630 is substantially similar to the pop-up window 600. However, the value field may be used to create UI components that are for display-only (e.g., not editable.) The pop-up window 630 may be similar to the pop-up window 600, with the exception of a Format field 632 which specifies the format of the displayed value.

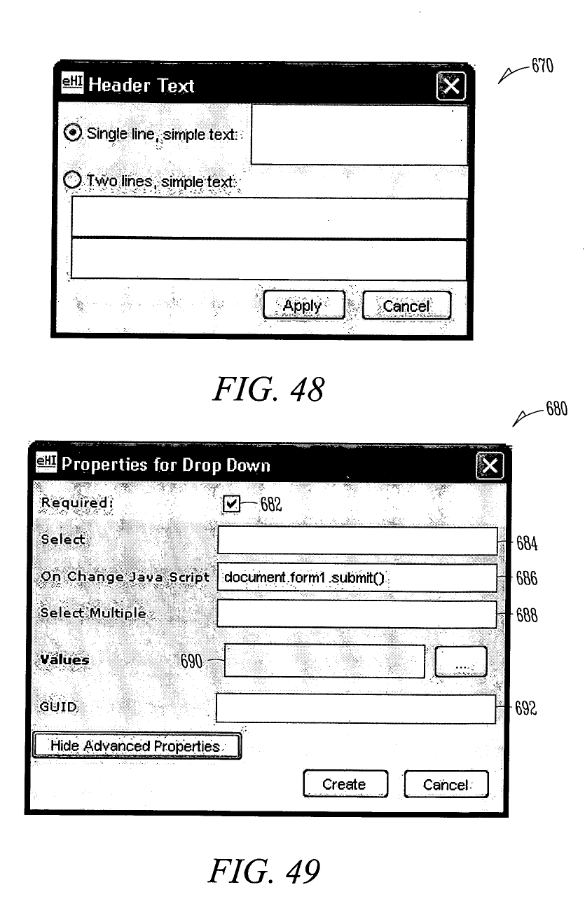

The UI component 300.4 may correspond to an ‘Add Table’ component that allows the user to drag-and-drop a table into the page layout zone 52. FIG. 47 shows an example pop-up window 640 that allows the user to customize the table and add to the form being built. As can be seen from the pop-up window 640, appropriate fields 642-656 and 662 may be provided that allow the user to customize the table. The Class field allows the user to select a table background from a drop-down menu 658 to allow the user to customize the background of the table. The Header Text input field 648 utilizes a pop-up window 670 and (see FIG. 48) that allows the user to customize the header text. The UI component table 300.4 (with rows and columns) may be used to layout the structure of the page. This component may be first be dragged and dropped to the page to create a table. Thereafter, other UI components may be dragged and dropped to create cells of the table on the page.

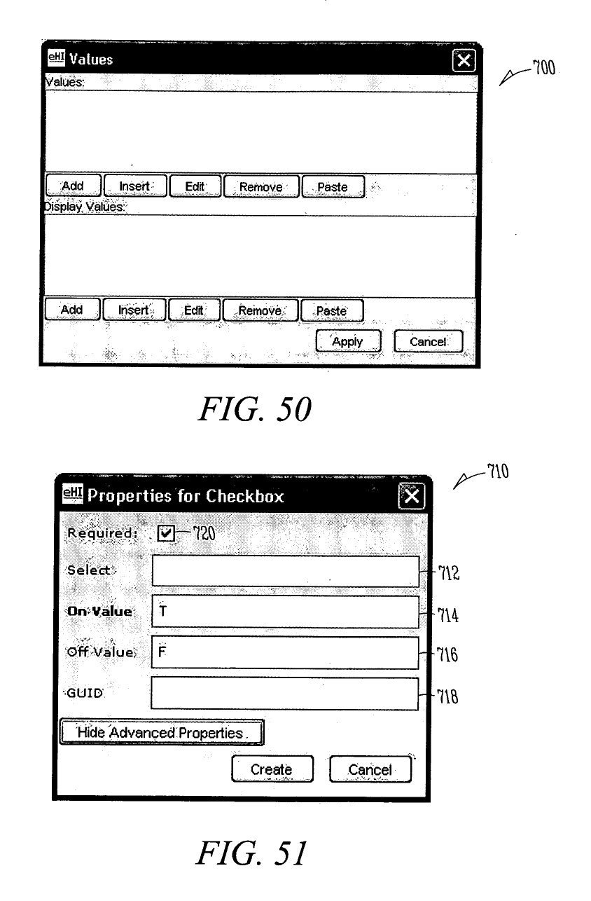

The UI component 300.5 may allow the user to include a drop-down menu in the application form being built. For example, when the user drags and drops the UI component 300.5 into the page layout zone 52, a pop-up window 680 (see FIG. 49) may be provided to allow the user to customize the characteristics or properties of the drop-down menu. The pop-up window 680 is shown, by way of example, to include a checkbox 682 and various appropriate fields 684-692. Using the various fields 684-692 the user may best define a particular drop-down menu is to be used in the form being built. In order to allow the user to define various value properties for a particular drop-down menu, a pop-up window 700 is provided (see FIG. 50).

In an example embodiment, to the UI component 300.6 may allow the user to a include checkbox in the application form being built. Upon selection of the UI component 300.6, a pop-up window 710 (see FIG. 51) may be provided. The pop-up window 710 is shown, by way of example, to include various appropriate fields 712-718 and the checkbox 719 that allows the user to define the properties of the checkbox included in the application form being built.

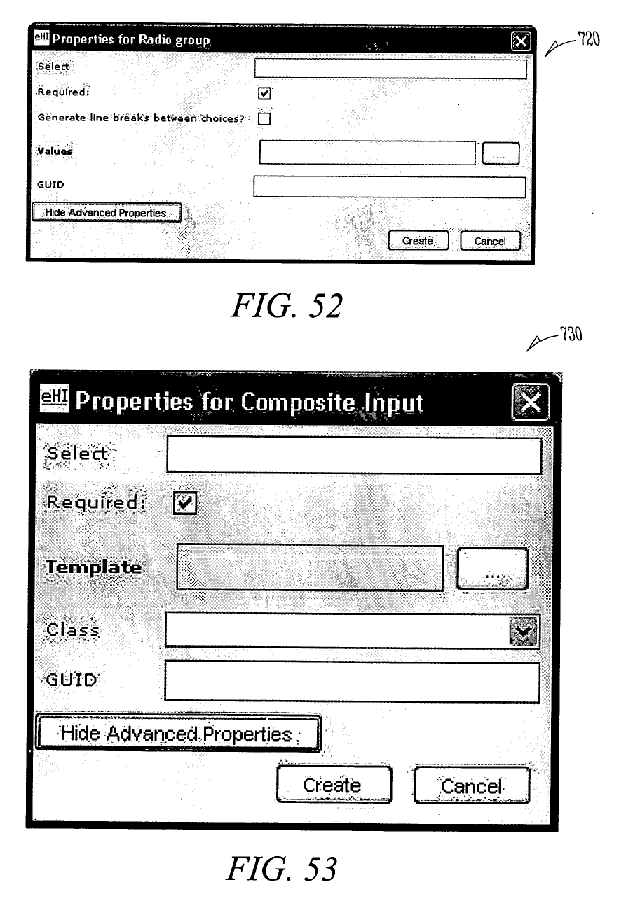

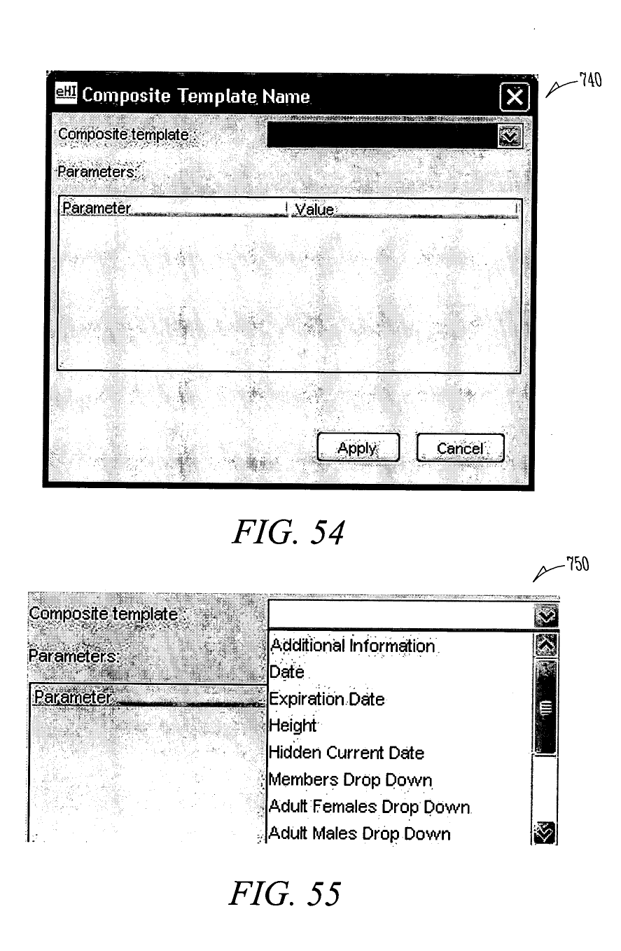

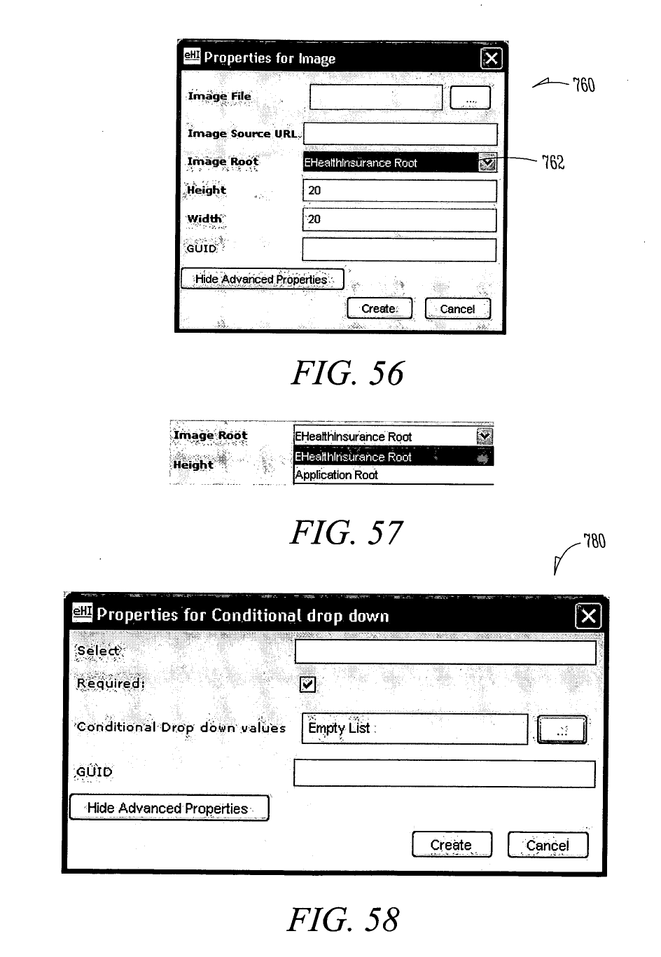

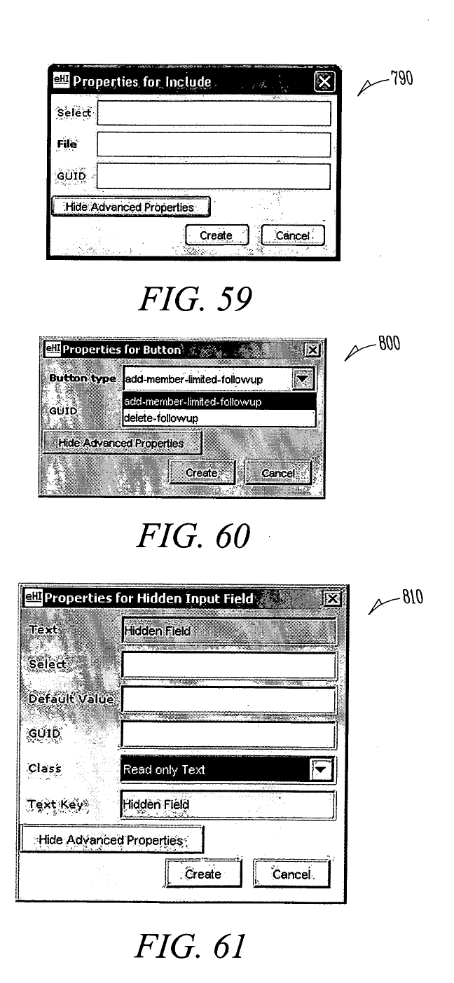

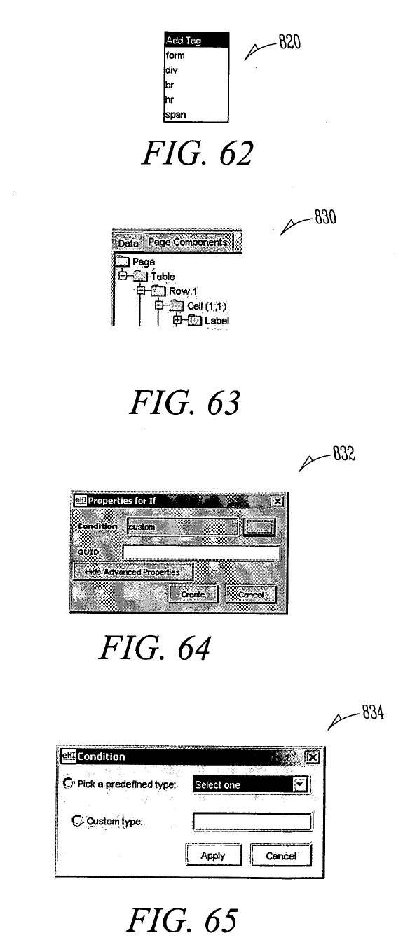

It will be appreciated that, dependent on the particular application form being built, various other UI components may be provided. Example, an ‘Add Radio Group’ UI component may be provided. FIG. 52 shows an example pop-up window 720 that allows the user to add radio button properties to an application form being built. FIG. 53 shows an example pop-up window 730 which corresponds to an ‘Add Composite Input’ UI component. A component input may be a set of UI input fields which are logically related to each other. Example component inputs include Area code with Phone number, height in feet and inches, etc. FIG. 54 shows an example pop-up window 740 which corresponds to UI component that allows the user to define composite template properties. FIG. 55 shows an example drop-down menu 750 that corresponds to a UI component that provides the user with a plurality of composite template drop-down options. FIG. 56 shows an example pop-up window 760 that corresponds to a UI component that allows a user to define properties of an image included in the application form being built. The pop-up window 760 may include an image root drop-down menu 762 that allow us the user to select an image (see also FIG. 57) for inclusion in the form. The pop-up menu 760 may allow the user to define characteristics of the image to be included in the form being built. In an example embodiment, an ‘Add Conditional Drop Down’ UI component is provided to allow the user to drag-and-drop a conditional drop down menu into the page layout zone 52. Conditional drop-downs may include two drop down menus where one menu depends on the applicant's selection in the other menu. An example of this includes a State/Province drop down menu that may be dependent upon the value selected in a separate Country drop down menu. In FIG. 58 an example pop-up window 780 is shown that may assist the user in defining properties of the conditional drop down menu. Reference 790 (see FIG. 59) shows an example pop-window that allows a user to define a path and a name of a template file. Reference 800 (see FIG. 60) shows an example pop-up window that allows a user to add a button to the HTML editor tab 292. Reference 810 (see FIG. 61) shows an example pop-up menu that allows a user to edit or add a hidden field and reference 820 (see FIG. 62) shows an example pop-up window 820 that allows a user to add HTML tags.

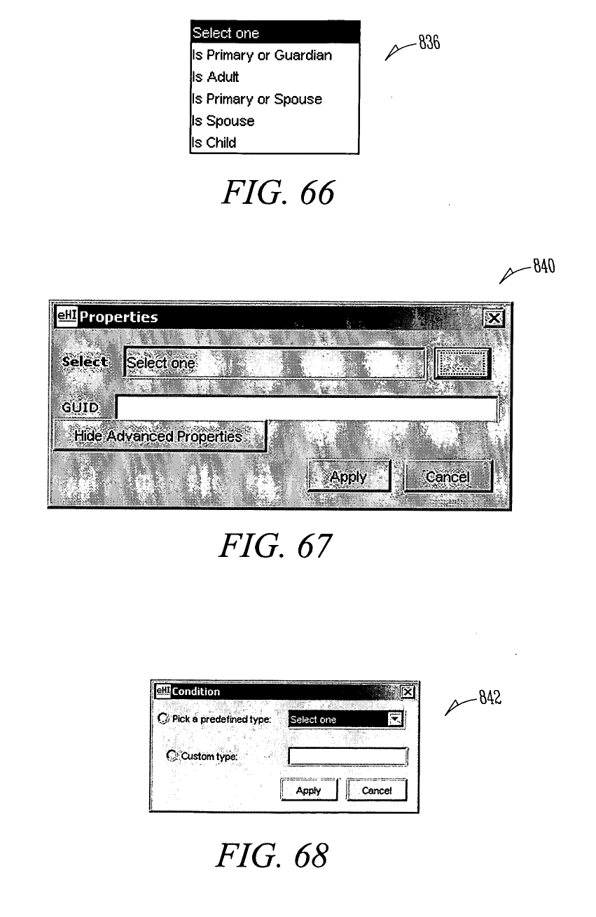

In an example embodiment, the system 10 allows a user to build an online application form that conditionally displays selected components in a table. Accordingly, the system 10 may provide a page components tab 830 (see FIG. 63) which allows the form designer to view the constructed UI components in a tree-like format (e.g., in table rows and table cells for each row). One example use of this view is to allow the form designer to conveniently select one or more rows and define display conditions for the selected rows. As shown by a pop-up window 832 in FIG. 64, selected components may be conditionally. They pop-up window 834 (see FIG. 65) allows the user to customize the condition based on example properties (see example properties 836 in FIG. 66). For example, the pop-up window 836 may be used to introduce the conditional if clause on an application page being built to determine, at runtime, whether the policyholder has a spouse.

In an example embodiment, an icon may be added to the UI toolbar 67 to allow the user to create a loop on selected components. For example, a pop-up window 840 (see FIG. 67) may be provided to allow the user to define properties for a particularly function. As shown in pop-up window 842 (see FIG. 68), may be provided define a condition which would trigger the loop

Application forms from various health insurance carriers may share common data or information. For example, in the health insurance industry circumstances may arise where about 20% of the data collected on an application form has the same meaning across all applications (different applications forms and/or different carriers). Data common to multiple application forms being built may be referred to as core-data. For example, a member's Social Security Number (SSN) may have the same meaning in all applications and thus may be categorized as core-data.

Each application form that is being built may be defined as a complete process from the moment the applicant starts the application (generated by the runtime engine), to submission of the application (e.g., a congratulations page presented to the user). This may incorporate pre-qualification, health history, underwriting, EPI, and so on. In an example embodiment, each application form built by the system 10 may be unique and need not share behavior with other applications forms that have been built. Thus, in an example embodiment, each application form may implement its own nuances without having to worry about incorporating those nuances into java code, templates, etc. The user may thus define a unique application form for a particular insurance product (e.g., health insurance plan) and the application form may be customized by a runtime engine when it is presented to an applicant in real time.

In an example embodiment, each online application form built by the system 10 may have a unique data model and a unique application process. In an example embodiment, the application form presented online to the applicant is generated on-the-fly by the runtime engine 18 and the actual pages generated from the data model may vary from applicant to applicant depending upon input received from the applicant. In an example embodiment, core-data from an initial census (available prior to applicant starting the application) may have already have been saved in a database (e.g., the database 39) before an application form is created for the first time. Thus, for a particular industry where the system 10 is to be deployed, a bootstrap file may be created. The bootstrap file may thus include initial data elements appropriate for a particular industry. As mentioned above the data elements may include core-data and other-data. Thus, the bootstrap file may include the core-data and other-data associated with a particular industry. In an example embodiment, prior to building the application form, a particular bootstrap file may be loaded. The bootstrap file may include all of the other-data elements that would be present initially. Thereafter, the core-data may be loaded from the database. This data loaded from the database may then be mapped to the core-data of the XML and the two parts may be combined to form the application form. In an example embodiment, optional core-data items may be applied and startup events may then be applied.

In an example embodiment, there may be sections in the core-data which are not present in all online application forms and may therefore be optional. An example of such core-data is EPI agreement signature data. If the application form does not provide EPI functionality, then this portion of core-data may be unnecessary.

Example Data Storage

In an example embodiment, application data may be stored or persisted in two ways. The core-data may be saved to the database (e.g., the database 16) as individual updates to database table/columns. Core-data may be mapped into a data tree object and given to AST. The AST may then update the database as necessary. The other-data (non-core-data) may, for example, be persisted in a different manner. For example, an XML sub-tree of the other-data may be dropped as a whole into a single field in the database.

Example Application Manifest

In an example embodiment, a ‘manifest’ may provide control of the online application building methodology. For example, the manifest may define a substantial number (possibly even all) of the components of the application building methodology, pages (and properties of these pages), and the flow between those pages. It may also define pre-qualification criteria in a health insurance application form and EPI functionality. In an example embodiment, the application manifest may be defined in an application directory. The directory may contain all the components of an application. This may include application page templates, EPI templates, business rules, a trigger file, the application schema and bootstrap, and the application PDF.

An example manifest for an insurance health care provider that includes both pre-qualification and EPI is shown below.

A first item in the manifest may specify optional core-data items:

<?xml version=“1.0” encoding=“UTF-8”?>
<application-manifest
xmlns=“http://www.ehealthinsurance.com/application/manifest”

xmlns:xsi=“http://www.w3.org/2001/XMLSchema-instance”

xsi:schemaLocation=“http://www.ehealthinsurance.com/application/manifest
http://www.ehealthinsurance.com/xml/schema/manifest.xsd”>

<optional-core-data>

<item>mailing-address</item>
<item>work-phone</item>
<item>fax</item>
<item>bank-account</item>
<item>payment</item>

<item>credit-card</item>

</optional-core-data>

In an example embodiment, if any one of these items is not specified in the manifest example provided above, they would be absent from the core-data. These items may be considered optional because not all applications require them.

Example Startup Events

Some data in the application form being built may be dependent on census information, and cannot be generated statically in the example bootstrap file. Thus, in an example embodiment, specified events may be executed at the time an application of the system 10 is loaded. Examples of these events (which may be listed in the manifest as startup events) are as follows:

<startup-event>

<name>add-any-sig-for-adults</name>
<param name=“loc” value=“//app:epi-agreement-sig” />

</startup-event>

In this example, an EPI agreement signature instance is generated for each adult member in an application form for health insurance. It may be impossible to do this statically in the bootstrap because at the time of building the application form, the user is not aware of what members will be provided by the applicant at runtime. The event ‘add-any-sig-for-adults’ may add a specified signature for all adult members. The location in the XML where the data will be added may be specified as a parameter “t”. In an embodiment, the root of the signature, ‘epi-agreement-sig’, may be placed in the bootstrap. Each startup event listed may get executed in order and may have any number of parameters.

Example Screens and Application Pages

At this point in the given example, the manifest has described what the initial data for the application builder should be. In an example embodiment, the rest of the manifest may comprise screen data and application pages data.

A screen may be a representation of a form screen object. In the manifest, the templates, business rules, and event handling for that screen may be described. The screen object itself may invoke functions in the manifest to obtain information about itself, and how to proceed. This may allow standard screen objects to be created that have variable behavior based on the data in the manifest. Screen definitions may define which screens to proceed to next, depending on the event that the user triggers.

Application pages may be significantly different. The application definition may define the ‘XMLApplication’ screen. Pages within the application may be sequentially ordered. In an example embodiment, the application pages may use the same UI framework, have buckets or reference pages (e.g., reference pages 54.1-54.n), and can have conditional screen flow associations. The application pages may process the same user selected events such as ‘Back’, ‘Forward’, ‘Save & Exit’, ‘Jump to another bucket’ or the like. Therefore, the screen flow may define when to skip pages moving forward based on given conditions. In an example embodiment, the screen flow system may automatically determine how to apply the aforementioned when the user clicks on a selected button (e.g., the ‘Back’). In an example embodiment, every page may be listed in the application manifest.

In an example embodiment, a ‘dummy’ startup screen may be provided that may not really exist physically as a screen, but simply tells the system 10 where the first screen should be. In an example embodiment, pre-qualification is first performed if the applicant has not already pre-qualified. Thus, in the given example, the following startup functionality may be provided:

<startup-screen>

<onEvent id=“Next”>

<if cond=“//app:pre-qual/*/@answer != “” >

<then>

<goToScreen id=“XMLApplication” />

</then>
<else>

<goToScreen id=“PreQualScreen” />

</else>

</if>

</onEvent>

</startup-screen>

The startup screen may process the applicant selected event ‘Next’ to determine what the first screen should be. In the example above, if all of the prequalification answers are not blank, then the application screen may be provided, otherwise, the pre-qualification screen may be provided.

Example Application Screen

An abridged application screen definition may be as follows:

<application exitScreen=“XMLSummaryScreen”>

<page bucket=“APPLICANT” number=“1”/>
<page bucket=“APPLICANT” number=“2”/>
<page bucket=“COVERAGE” number=“3”>

<transition page=“5”>

<assert cond=“not(//app:coverage/*[position( ) &gt; 1]/@answer =

‘Y’)”/>

</transition>

</page>

The attribute ‘exitScreen’ may define a screen that will be transitioned to when no more application pages are available for display The exit screen may correspond to the end node 62 in FIG. 3. In this example, a summary screen is presented to an applicant after the last application screen has been displayed to the applicant. Each page in the application may be listed. It will be appreciated that a page element may be followed by any number of transitions to other pages. The default transition may be to the next sequential page. Each transition may be made of an assertion or assertion group which specifies one or more conditions. If the assertion is met, then the transition occurs.

Example Screen Definitions

An example screen definition provided in the manifest is as follows:

<screen id=“PreQualScreen”>

<template

id=“body”>applications/ifp/TX/Unicare/pages/preQual.xml</template>

<template id=“buttons”>app/prequal/PreQualNavigation.xml</template>
<rules>applications/ifp/TX/Unicare/pages/preQual.xml</rules>
<onEvent id=“Next”>

<goToScreen id=“XMLApplication” />

</onEvent>
<onEvent id=“Denied”>

<goToScreen id=“PreQualDenial” />

</onEvent>

</screen>
<screen id=“PreQualDenial”>

<template

id=“body”>applications/ifp/TX/Unicare/pages/preQualDenial.xml</template>

<template id=“buttons”>app/prequal/DenialNavigation.xml</template>
<rules>applications/ifp/TX/Unicare/pages/preQualDenial.xml</rules>

</screen>

A screen may, for example, comprise templates, rules, and event handling. The ‘screen id’ may reference a screen object. The screen object may invoke the manifest methods at an appropriate time. In an example embodiment, the manifest need not control the screen but may provide the information to the screen so that it can control itself. In an example embodiment, screens may be built with a fair degree of generality, and the manifest may define important specific properties. This also may allow any application to have a unique screen flow.

Dependent upon how the user builds an application form, circumstances may arise where a screen is made up of a set of templates. These templates may be processed for the UI in the order they are listed in the manifest. This may be the case where the screen will use a common set of buttons, or a common header, but have a unique UI elsewhere. An example in health insurance industry may be a pre-qualification screen (PreQualScreen), where a locally defined preQaul.xml template may be used, but is followed by a common set of preQual navigation buttons. In an example embodiment, business rules for a page may be listed under a single rules element. The rules may be embedded in one of the template files.

The screen definition may specify a series of actions to be taken upon the occurrence of various events (e.g., applicant navigation during completion of an online application form). In the example above, if there is a ‘Next’ event, the applicant may proceed unconditionally to the application form. If there is a ‘Denied’ event, the applicant may be presented with a denial screen.

In an example embodiment, it may not be necessary to have a definition for the target screen in the ‘goToScreen’ element if these screens have been predefined by the system. For example:

<screen id=“eSignature” >

<template id=“header”>app/epi/eSignatureHeader.xml</template>
<template id=“sig”

>applications/ifp/TX/Unicare/epi/eSignature.xml</template>

<template

id=“buttons”>app/epi/eSignatureButtons.xml</template>

<rules>applications/ifp/TX/Unicare/epi/eSignature.xml</rules>
<onEvent id=“Agree” >

<goToScreen id=“Congratulations” />

</onEvent>
<onEvent id=“Disagree” >

<goToScreen id=“MailVerfication” />

</onEvent>

</screen>

Example Management of Data

As mentioned above by way of example, data within an example online health application form may fall into two categories. If the data is not specifically related to a single member on an application form but to the whole application, then that data may be considered to be application based data. An example of application based data may state as follows:

<app:language-preference/>
<app:other-language/>
<app:ethnicity/>

On the other hand following the example given above, if the data is specifically related to a member of the application, then that data may be considered to be member based data. Member based data may takes the following form in the schema:

<member number=“1”>

... some subtree of data ...

</member>

For example:

<smoking answer=“Y”>

<member number=“1”>

<how-long />
<packs-per-day />

</member>
<member number=“2”>

...

</member>

</smoking>

It will be appreciated that when building an application form for rendering at runtime, some portion of the data needed may be non-dynamic data. For example, the user building the application form may know what non-dynamic data is to be included in the application form. However, dynamic data may thus be based on an answer to a question presented to the applicant. In an example embodiment, the policy based data may be fixed in the bootstrap and statically defined. However, member-based data may only be determined at runtime based on applicant input. For example, a user building an online application form does not know how many members the online application form needs to accommodate as this may vary from applicant to applicant and can only be determined from the applicant's input at runtime. It will thus be appreciated that this data cannot be statically defined in the bootstrap. It may thus need to be initialized in some other way at runtime.

The core-data may already have the member-based census data defined. In order to obtain additional-member based data, in an example embodiment a ‘member-ext’ may be used. This may be provided as a root under the other-data section. The manifest may issue a startup event to ‘add-member-ext’, which takes care of adding additional data elements for each member. A trigger data template member-ext may be used to define the aforementioned functionality. For example:

<etr:data-template id=“member-ext”>

<app:member number=“”>

<app:medicare-eligible/>

</app:member>

</etr:data-template>

Example Follow-Up Questions/Pages

Most of the data in an online health insurance application form may not be core-data is thus not common to all application forms. In order to capture this information, in an example embodiment follow-up questions are provided to the applicant at runtime. Thus, in an example embodiment, a substantial part of the data required in an online health insurance application form is acquired as a result of a response by the applicant to some question presented to the applicant by the runtime engine. In an example embodiment, data in a follow-up may be either application-based (e.g., dependent upon requirements of a health insurance carriers providing the health insurance that the applicant is requesting, but not specific to a member of the applied) or member-based (e.g., dependent upon member-specific factors). Such data may always the dynamic in the sense that the data is added at runtime and thus not provided in the example bootstrap. However, in an example embodiment, the root of the data may be in the bootstrap.

An example of a application based follow-up question may be as follows: ‘Was a translator used in the preparation of this application?’ For example, if the applicant responds with ‘Yes’, a series of questions about the translator may be required and thus be presented to the applicant to respond to. It will be noted that this data is not related to any specific member, and may therefore be categorized as application-based data. As a number of questions may be presented to the applicant in response to the abovementioned example question, the question may be regarded as a ‘root question’. In an example embodiment, a value associated with a response to the root question may be monitored. For example, if the user building the application form associates a ‘Yes’ value with follow-up questions, then follow-up data may be added to the root question. If the question associates ‘No’ value, then follow-up data may be removed from the root question for the particular application form being built.

In an example embodiment, in order to implement follow-up question functionality, a data template id for the follow-up data in the trigger is named according to the type of the root question. For example, the definition of the element that holds the translator question may be as follows:

<xs:element name=“translated” type=“translationType”/>

The definition of the type may be as follows:

<xs:complexType name=“translationType” >

<xs:complexContent>

<xs:extension base=“yn-question”>

<xs:sequence minOccurs=“0”>

<xs:element name=“translator-name” type=“xs:string”
/>
<xs:element name=“read-no-english”
type=“booleanType” />
<xs:element name=“write-no-english”
type=“booleanType” />
<xs:element name=“speak-no-english”
type=“booleanType” />
<xs:element name=“other” type=“booleanType” />
<xs:element name=“other-explanation”
type=“xs:string” />
<xs:element name=“applicant-sig” type=“xs:string” />

</xs:sequence>

</xs:extension>

</xs:complexContent>

</xs:complexType>

In an example embodiment, the specific ‘translationType’ is an extension of the general ‘yn-question’ type which carries an ‘answer’ attribute. This means the translationType also carries an ‘answer’ attribute by inheritance. This field may hold the applicant's response to the root question.

In an example embodiment, a data template may be provided that is named the same as the type. This template may comprise internal questions for the root question. An example data template may be as follows:

<etr:data-template id=“translationType” >

<app:translator-name />
<app:read-no-english />
<app:write-no-english />
<app:speak-no-english />
<app:other />
<app:other-explanation />
<app:applicant-sig />

</etr:data-template>

In an example embodiment, a built-in trigger mechanism may put this all together. For example, when the value of the ‘translated’ question changes, the system 10 may take the appropriate action defined during the building of the application form by the user, and the sub-questions may be added or a question automatically added. For example, the system 10 may automatically identify a template to use by obtaining the ‘type’ of the root question, and using that as the name of the template id.

EPI (Electronic Processing Interface)

As described by way of example above, an embodiment of system 10 allows a user to build an online application form that supports EPI functionality and, accordingly, the application form generated by the runtime engine may thus support electronic signatures. For example, an online application form may have a signature for agreement to the terms of the application. They may also be a signature for credit card payment, electronic funds transfer (EFT), or the like. Further, there may be signatures related to other items on the application.

Digital signatures may require some sort of acknowledgment. Thus, a check box may be provided on the online application form to allow the applicant to acknowledge or confirm that a particular message, notice, agreement, or the like has been read and understood, followed by a signature request. It will be appreciated that there may be multiple acknowledgments for a single signature.

The party or parties signing an application form may vary in different circumstances. In an example online health application form, the agreement may be signed by parties on the application. In the case of credit card and EFT signatures, the signatory is not necessarily related to the applicant or applicants. If the signatory is a member of the application, it may be necessary to know which members of the application are relevant. In an example embodiment three choices for signature may be provided namely, the primary applicant alone, the primary applicant and the spouse of the primary applicant, or all the adult members included in the application form.

Example Signature Types

In an example embodiment, a base ‘types.xsd’ may define a ‘signatureType’ which may include the relevant standard signature data:

<app:member number=“” >

<app:name>

<app:first-name />
<app:middle-name />
<app:last-name />

</app:name>
<app:confirmation

<app:first-name />
<app:middle-name />
<app:last-name />

</app:confirmation>
<app:date-signed>

<app:day />
<app:month />
<app:year />
<app:hours />
<app:minutes />
<app:seconds />

</app:date-signed>
<app:city-signed />
<app:state-signed />

In an example embodiment, all signatures may include the aforementioned information.

As signatures may also include acknowledgments, certain embodiment of the system 10 may not predefine any signature, even the most common ones, in the core-data. Therefore, in an example embodiment all signatures are defined in the other-data section, and may be defined as extensions of the ‘signatureType’. Signatures may, for example, fall into two categories. Member based signatures for signatories related to the applicants, and fixed signatures where a single signature is needed, and that signatory is not related to the applicants.

An example of a fixed signature is credit-card signature for a given application. The signatory is the owner of the credit-card, and the signatory may or may not be one of the applicants. A single acknowledgement in the online application for may be provided for the credit card. The schema for this item may be as follows:

<xs:complexType name=“creditCardSignatureType”>

<xs:complexContent>

<xs:extension base=“signatureType” >

<xs:sequence>

<xs:element name=“ack-credit-card” />

</xs:sequence>

</xs:extension>

</xs:complexContent>

</xs:complexType>
<xs:element name=“debit-cc-sig” type=“creditCardSignatureType” />

In an example embodiment, signature type is extended to include the acknowledgement, and the system 10 may define an element to hold the signature. The following may for example be included in the bootstrap file to initialize the data structure for collecting signatures:

<app:debit-cc-sig >

<app:name>

<app:first-name />
<app:middle-name />
<app:last-name />

</app:name>
<app:confirmation>

<app:first-name />
<app:middle-name />
<app:last-name />

</app:confirmation>
<app:date-signed>

<app:day />
<app:month />
<app:year />
<app:hours />
<app:minutes />
<app:seconds />

</app:date-signed>
<app:city-signed />
<app:state-signed />
<app:ack-credit-card />

</app:debit-cc-sig>

A fixed signature may essentially be static. It may hold a single signature that is unrelated to any applicant. However, a more complex scenario may arise for member based signatures. Member based signatures may, for example, require three acknowledgements:

<xs:complexType name=“agreementSignatureType” >

<xs:sequence>

<xs:element name=“member” minOccurs=“0”

maxOccurs=“unbounded” >

<xs:complexType>

<xs:complexContent>

<xs:extension base=“signatureType” >

<xs:sequence>

<xs:element name=“ack-app”

/>

<xs:element name=“ack-

disclosure” />

<xs:element name=“ack-sig”

/>

</xs:sequence>

</xs:extension>

</xs:complexContent>

</xs:complexType>

</xs:element>

</xs:sequence>

</xs:complexType>

Since the number of members associated with an online application form is not known until runtime, placeholders may not be statically defined for the signatures. Thus, in an example embodiment, the bootstrap addition to this functionality may be as follows:

<app:epi-agreement-sig/>

A data template in the triggers may be provided for this signature. The template id may be the same as the type of the element:

<etr:data-template id=“agreementSignatureType” >

<app:member number=“” >

<app:name>

<app:first-name />
<app:middle-name />
<app:last-name />

</app:name>
<app:confirmation>

<app:first-name />
<app:middle-name />
<app:last-name />

</app:confirmation>
<app:date-signed>

<app:day />
<app:month />
<app:year />
<app:hours />
<app:minutes />
<app:seconds />

</app:date-signed>
<app:city-signed />
<app:state-signed />
<app:ack-app />
<app:ack-disclosure />
<app:ack-sig />

</app:member>

</etr:data-template>

Further, an event may be generated at application startup that will initialize the required member signatures. As stated above, in an example embodiment, the online application form may require just the primary applicant's signatures, or may also require the spouse, or may require all adult members. The following three example standard events may generate signature data:

add-any-primary-signature -- Add a signature solely for the primary
member
add-any-primary-spouse-signature -- Add a signature for the primary
member, and the spouse if present
add-any-sig-for-adults -- Add a signature for all adult members
(e.g., 18 or over.)

Each one of these events may take a parameter ‘loc’. This ‘xpath’ value may indicate the root node of the signature. In an example embodiment, thus root node is present at the time the application is initialized.

The event may be created in the manifest file. In an example embodiment, add signatures are added for all adult members. In the manifest, this may be represented as follows:

<startup-event>

<name>add-any-sig-for-adults</name>
<param name=“loc” value=“//app:epi-agreement-sig” />

</startup-event>

EPI signatures may be defined in the other-data section and may be placed under a common root EPI-data. Thus, for example, the following schema may be applied:

<xs:element name=“epi-data”>

<xs:complexType>

<xs:sequence>

xs:element name=“epi-agreement-sig”
type=“agreementSignatureType” />
<xs:element name=“debit-cc-sig” in the
type=“creditCardSignatureType” />
<xs:element name=“debit-account-sig”
type=“accountSignatureType” />
<xs:element name=“accident-replacement-sig”
type=“signatureType” />

</xs:sequence>

</xs:complexType>

<xs:element>

The above may allow all incomplete signatures to be ‘blanked out’. Having a common root may allow the system to find the EPI data more easily.

Example Riders

In an example embodiment, events may be predefined for an application form that is being built and, accordingly, in these circumstances no additional events may need to be created to deal with rider follow-up questions. In an example embodiment, a follow-up question may be added to the schema, and the data template may provide the follow-up data to associated triggers. Each rider may have a category name, such as ‘Life Insurance’ or “Dental’. A parent node of the example follow-up question and the data template for the follow-up data may be based on the category name. For example when a healthcare insurance carrier requires beneficiary information for life insurance riders the following may be defined in the schema:

<xs:complexType name=″Life-Insurance-followupType″>

<xs:sequence>

<xs:element name=”member” >

<xs:complexType>

<xs:complexContent>

<xs:extension base=”member”>

<xs:sequence minOccurs=″0″>

<xs:element name=″initials″
type=″xs:string″ />
<xs:element name=″name″
type=″name″ />
<xs:element name=″relationship″
type=″xs:string″ />
<xs:element name=″address″
type=″addressType″ />

</xs:sequence>

</xs:extension>

</xs:complexContent>

</xs:complexType>

<xs:element>

<xs:sequence>

</xs:complexType>

In an example embodiment, the category name may for example be ‘Life Insurance’. The root node of the follow-up in this example embodiment may be ‘Life-Insurance-follow-up’. Every application with a life insurance rider follow-up question may have a root node with the same name. The contents of that follow-up question may be defined for that application specifically. In an example embodiment, the bootstrap may have the following additional line:

<app:Life-Insurance-followup/>

In an example embodiment, trigger file may have the following example data template:

<etr:data-template id=″Life-Insurance-data″ >

<app:member @number=”” />

<app:initials />
<app:name>

<app:first-name />
<app:middle-name />
<app:last-name />

</app:name>
<app:relationship/>
<app:address>

<app:street/>
<app:street-line-2/>
<app:city/>
<app:state/>
<app:zip/>
<app:county/>
<app:apt-number-or-suite/>
<app:po-box/>

</app:address>

</app:member>

</etr:data-template>

Example Runtime Engine

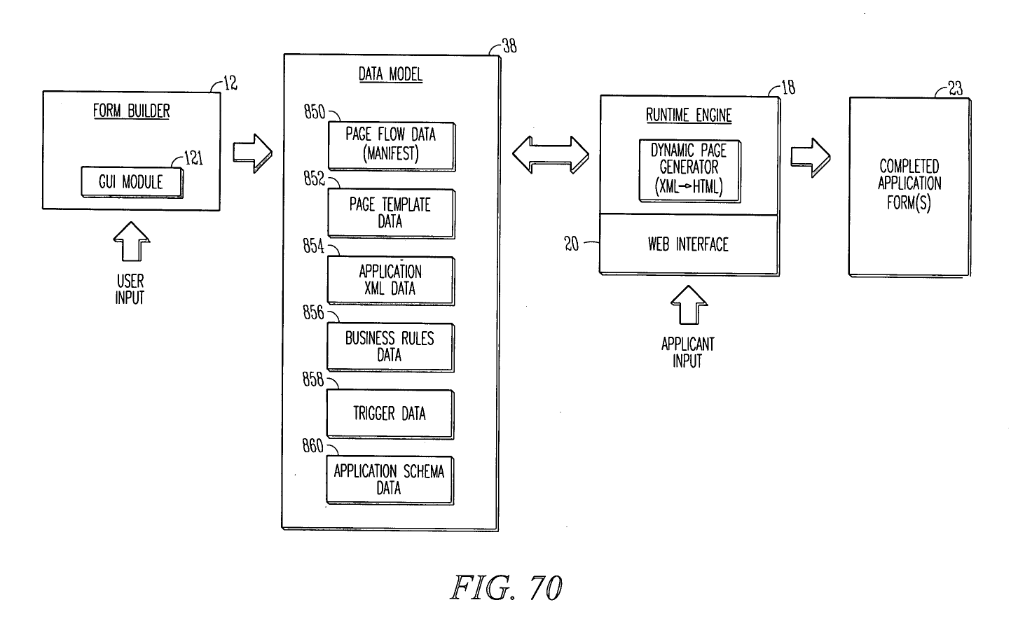

Thus, as shown in FIG. 70, a user interacting with the form builder 12 may design and build documents which are defined in a data model 38 in a storage media 16. In an example embodiment, the data model 38 is an XML data structure from which HTML web pages are generated on-the-fly by the runtime engine 18. These HTML web pages are presented to an applicant completing an online application document by a Web interface 20 of the runtime engine 18. Once the applicant has completed the application documentation and, for example, electronically signed the application document then the completed application form 23 is provided to carrier associated with the particular online application form. In certain circumstances, the application form may require an actual signature thus requiring the applicant to print the completed application form and mail it to the associated carrier.

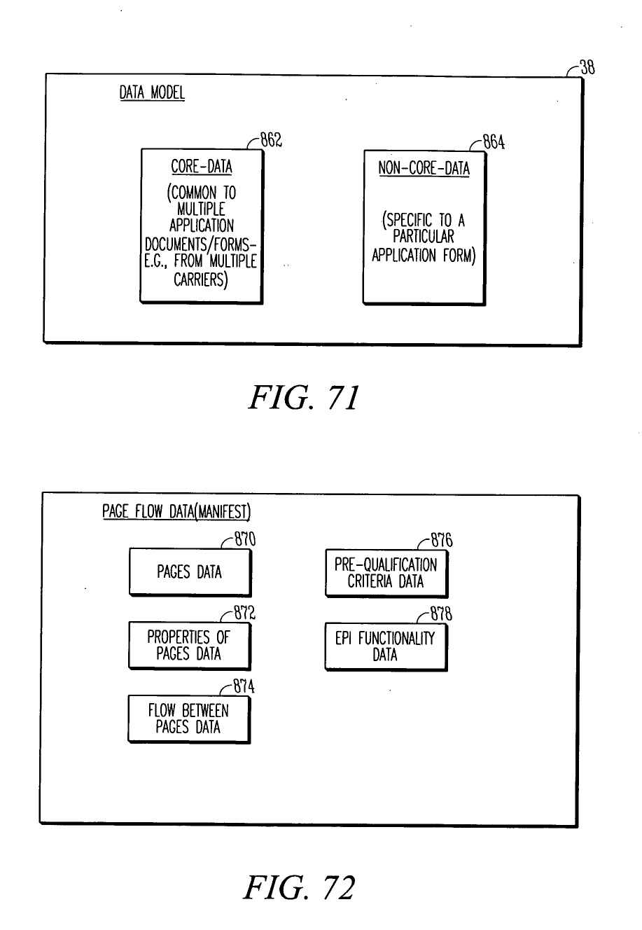

In an example embodiment, the data model 38 may comprise page flow or manifest data 850, page template data 852, application XML data 854, template rules data 856, trigger data 858, and an application schema data 860. It will be appreciated that the data model 38 may vary from one embodiment to another. As mentioned above, the data model 38 may be arranged into core-data 862 and non-core or other-data 864 (see FIG. 71). In an example embodiment, the core-data 862 may be data that is common to multiple application documents that have been built. For example, the core-data 862 may be common to application documents from a plurality of different health insurance carriers. Examples of such core-data by shown by way of example in FIG. 11. The non-core-data 164 may be data that is specific to a particular application document. Examples of such non-core-data are shown in FIG. 12. As shown in FIG. 72, in an example embodiment the page flow data or manifest 850 may include page data 870, properties of pages data 872, flow between pages data 874, prequalification criteria data 876, EPI functionality data 878, and other relevant data.

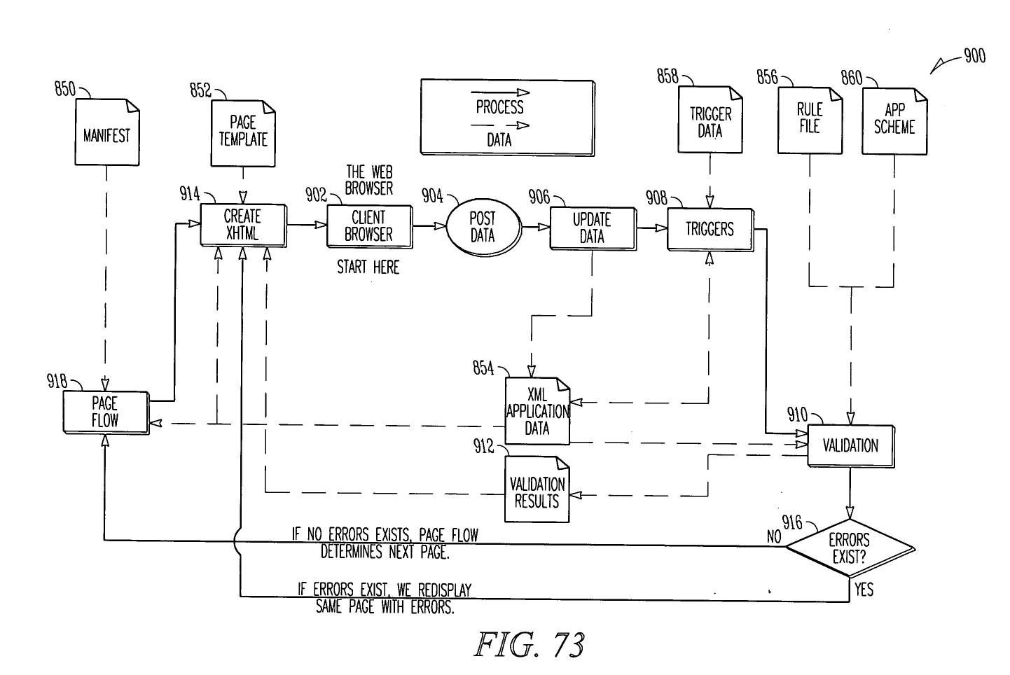

Referring in particular to FIG. 73, reference 900 generally indicates a method, in accordance with an example embodiment, for rendering documents to an applicant via a network by the runtime engine 18. In an example embodiment, the method 900 renders HTML web pages to an applicant via the Internet. Multiple iterations of the method steps shown in FIG. 73 may each render an appropriate application page of an online application document or form.

Initially a start page may be rendered to the applicant and, as described in more detail herein, subsequent pages are then generated on-the-fly depending upon an answer or data entered by the applicant during an online application process. For example, a user entered ZIP code, gender and date of birth may be posted to the XML data model 38 and, based on this data, one or more health insurance plans that the applicant may be eligible for may be presented to the applicant. The start page may, for example, display a number of potential health insurance plans provided by a plurality of health care providers or carriers. The applicant may then select an appropriate health insurance plan and click “apply” whereupon the particular selection may then be posted. The method 900, as described in more detail below may then present the first page in an application document associated with the health insurance plan to the applicant. Further pages are then sequentially presented to the applicant on-the-fly by the method 900.

As shown at block 902, the applicant may be presented with a web page requesting the applicant to enter relevant data or information. After the applicant has entered the relevant data or information, as shown at block 904 the method 900 may then post the data to the runtime engine. Accordingly, as shown at block 906, the data structure may be updated. For example, the application XML data 854 may be updated with the relevant information that has been entered by the applicant. Dependent on the specific data entered by the user, one or more triggers (see block 908) may be triggered. Thus, trigger data from the trigger data 858 in the data model 38 may be accessed. Thereafter, as shown at block 910, the method 900 may perform a validation step in which the data entered by the applicant is validated. In response to the validation step at block 910, validation results 912 may be communicated for subsequent use in creating an XHTML document to be sent back to the user (see block 914).

Returning to the validation block 910, as shown at decision block 916, if the information entered by the applicant does not pass the validation test, a new web page in the dynamic sequence is not required. Instead, the method 900 may proceeds to generate an error page which is then presented to the applicant. The error page may be the previous web page presented to the applicant highlighting those areas requiring correction or further information that may have been omitted. This web page may request the applicant to complete or modify the information entered. If, however, the information entered by the user passes the validation test in block 910, then the method 900 proceeds to identify the next page to be generated and presented to the applicant (see block 918. As herein described, page flow data 850 may identify the next page to be generated and presented to the applicant based on the information entered by the applicant. Accordingly, the method 900 then proceeds to create an XHTML page (see block 914). Data to create the next web page presented to the applicant is provided by the page template data 852.

Returning to the validation step shown at block 910, in an example embodiment template rules data may define the required data or information that is to be entered by the user. An example of these rules includes business rules (see business rules data 856) which may be defined by a health insurance carrier. In addition, the application schema data 860 may be accessed when performing validation.

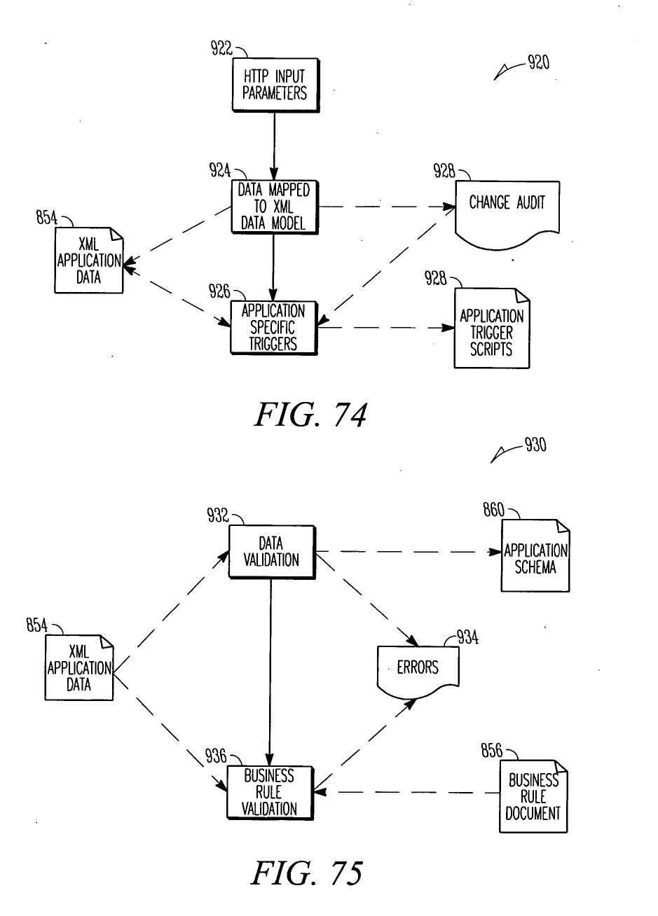

Referring in particular to FIG. 74, reference 920 generally indicates a method detailing the process block 906 in FIG. 73, in accordance with an example embodiment, to update data in an XML data structure or model (e.g., the data model 38). As shown at block 922, HTTP input parameters may be received and, thereafter, mapped to the XML data model 38 as shown at block 924. As hereinbefore described, application specific triggers may then be activated (see block 926). When the data is mapped to the XML data model 38 in block 924, the XML application data 854 may be updated as well as a change audit (see block 928). In order to activate the application specific triggers (see block 926), application trigger scripts 928 which define the actions of the triggers may be provided. Triggers may be used to dynamically change the data defined in the data model 38. For example, adding “follow-up” data if an applicant answered the question as “yes” (see the History Follow-up page 318 in FIG. 14A).

In an example embodiment, at the same time when data is mapped to the data model 38, a check is conducted to determine if the data received through http parameters has been changed. For example, the applicant may previously have entered data and then subsequently changed it. A record of such changes may be kept in the change audit 928. The change audit may thus keep track of what data has been changed. It will be appreciated that changes in the data may influence the triggers and hence the change audit may be used to control the execution of triggers.

Thus, when the applicant inputs information into a web application form (e.g., via a web browser), which is then posted back to the server (see block 904), the data model 38 may be updated. The runtime engine 18 at block 908 checks to see if any of the data posted would cause an associated trigger to be activated. For example, a web page presented to the applicant completing an online application form may ask certain medical questions. For example, one of the questions may be “Do you have a heart problem?” If the applicant responds in the affirmative (e.g., by checking a “Yes” checkbox) then in the example shown in FIG. 14A the “History Follow-up” page 38 may be generated and presented to the user. However, if the applicant responded with “No” then no trigger will be activated. In an example embodiment, the trigger functionality in block 908 evaluates the data posted and updates the data model 38 accordingly. This data is then subsequently used in block 914. In an example embodiment, a trigger may only be triggered in response to answers or responses to multiple questions posed on a page and thus a trigger should not be activated until all responses have been received. In an embodiment, the triggers define the dynamic part of the data structure or model 38. Thus, in response to a trigger, the data model may be modified e.g., to accommodate the further data which is then required from the applicant. Thus trigger data may be considered as other data and, for example, may not be hard coded as the case may be with core-data which is common to multiple application forms.

In an example embodiment, a trigger may then add additional specific storage into the XML data schema to anticipate further data that is to be captured. For example, further storage for the follow-up questions presented in the history follow-up page 318 may be provisioned to store the applicant's response.

A method 930 is shown in FIG. 75 to validate data or information entered by the applicant. The method 930 may be performed in the validation block 910 shown in FIG. 73. Inputs to the validation process shown at block 932 may be obtained from the application schema data 860 as well as the XML application data 854. Errors reported during the validation process are recorded as shown at block 934. Business rules validation is shown to be performed at block 936 and errors identified during the business rule validation process are also recorded (see block 934). Input rule data to the business rule validation functionality is provided by the business rules data 856. For example, if the applicant when entering data violates a data type or a business rule, then the method 930 will flag an error. An example of an error can be where the applicant has entered a social security number but in an incorrect format or with the incorrect number of digits. Further, the form builder may have defined rules so that if an applicant answers one particular question in a particular fashion then another question of the page also requires an answer. It will be appreciated that the various rules may be defined by the form builder and defined in the data model 38.

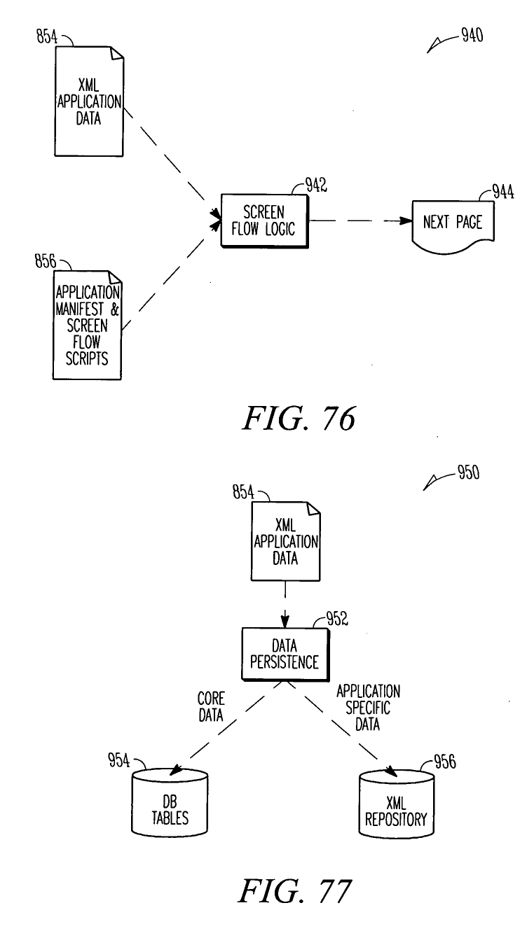

Example functionality performed in block 918 of FIG. 73 is shown in FIG. 76. In particular, reference 940 generally indicates data flow to control screen flow logic (see block 942) which defines a sequence in which pages are presented to the applicant. Inputs to the screen flow logic include the XML application data 854 and the page flow data (manifest) 850 which may include screen flow scripts. The screen flow logic in block 942 processes these inputs and the next web page (see block 944) to be presented to the applicant is then generated on-the-fly and presented to the applicant. For example, and referring by way of example to FIG. 14A, if the previous page presented to the applicant was a health history page that triggered one or more health history follow-up questions, the next page presented to the applicant would be the health history follow-up page 318. However, still following the example of FIG. 14A, if no further health history questions are required, the next page presented to the applicant would be the rider page 320. Thus, the runtime engine 18 dynamically generates appropriate web pages which are then presented to the applicant dependent upon responses (data captured) from the applicant to questions presented in a previous web page.

Referring to FIG. 77, reference 950 generally indicates data flow for persisting data or information entered by applicant during an online application process. The data persistence process may take place whenever the XML application data is updated by the runtime engine 10. As shown at block 952, XML application data 854 may be stored in one or more databases. For example, the core-data 862 may be persisted in a database 954 and the non-core-data 864 may be persisted in XML repository database 956.

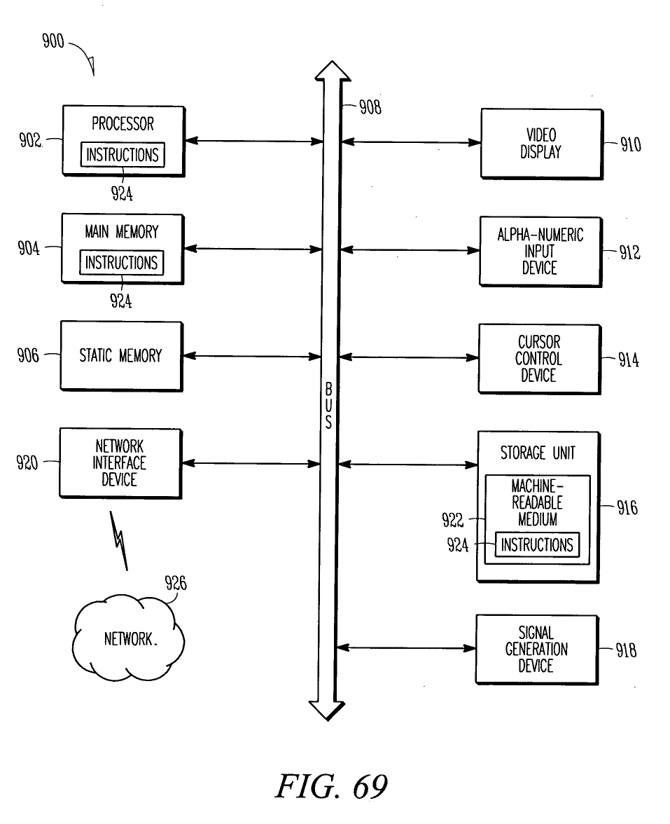

FIG. 69 shows a diagrammatic representation of machine in the example form of a computer system 900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to comprise any collection of machines that individually or jointly execute a set (or multiple sets) of instructions to perform any one or more of the methodologies discussed herein.

The example computer system 900 comprises a processor 902 (e.g., a central processing unit (CPU) a graphics processing unit (GPU) or both), a main memory 904 and a static memory 906, which communicate with each other via a bus 908. The computer system 900 may further comprise a video display unit 910 (e.g., a liquid crystal display (LCD) or a cathode ray tube (CRT)). The computer system 900 also comprises an alphanumeric input device 912 (e.g., a keyboard), a cursor control device 914 (e.g., a mouse), a disk drive unit 916, a signal generation device 918 (e.g., a speaker) and a network interface device 920.

The disk drive unit 916 comprises a machine-readable medium 922 on which is stored one or more sets of instructions (e.g., software 924) embodying any one or more of the methodologies or functions described herein. The software 924 may also reside, completely or at least partially, within the main memory 904 and/or within the processor 902 during execution thereof by the computer system 900, the main memory 904 and the processor 902 also constituting machine-readable media.

The software 924 may further be transmitted or received over a network 926 via the network interface device 920.

While the machine-readable medium 922 is shown in an example embodiment to be a single medium, the term “machine-readable medium” should be taken to comprise a single medium or multiple media (e.g., a centralized or distributed database, and/or associated caches and servers) that store the one or more sets of instructions. The term “machine-readable medium” shall also be taken to comprise any medium that is capable of storing, encoding or carrying a set of instructions for execution by the machine and that cause the machine to perform any one or more of the methodologies of the present invention. The term “machine-readable medium” shall accordingly be taken to comprise, but not be limited to, solid-state memories, optical and magnetic media, and carrier wave signals.

Although the network-based system 10 is described, by way of example, with reference to health insurance plans it will be appreciated to a person of skill in the art that it is not limited to health insurance plans or any other types of insurance plans.

Thus, a method and system are described to build an online application form which, in an example embodiment, is a health insurance application form. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method of providing an application form via a network, the method comprising:
accessing page flow data, page data and rules data stored in a storage media;
generating a graphical user interface (GUI) that provides a first application page to capture data from an applicant, the first page being generated dynamically from the page data;
providing the first application page to the applicant via a network;
monitoring entry of application data by the applicant;
processing and storing the application data, the processing including
validating the application data based on the rules data; and
identifying at least one subsequent application page based on the application data and the page flow data;
providing the at least one subsequent application page via the network to the applicant, the subsequent application page being generated dynamically from the page data; and
repetitively dynamically generating and providing subsequent application pages to the applicant based on the page flow data and the rules data.

2. The method of claim 1, wherein the page flow data, the page data and the rules data is Extensible Markup Language (XML) data, the providing of the first and subsequent application pages comprises:
accessing the page flow data, the page data and the rules data in XML;
generating HyperText Markup Language (HTML) pages from the XML, the HTML pages being generated dynamically in response to the application data, the page flow data, the page data and the rules data; and
providing the HTML pages to the applicant via the network.

3. The method of claim 1, wherein the page flow data, rules data and the page data in the storage media provides an abstraction layer between an application form and an HTML page generated dynamically at runtime.

4. The method of claim 1, which comprises accessing:
core-data identifying data that is common to a plurality of application forms; and
other-data that is specific to an associated application form.

5. The method of claim 1, in which the page flow data defines one or more follow-up reference pages which are specific to application data requested on an associated page.

6. The method of claim 5, wherein the rules data includes business rules associated with a specific application form provider.

7. The method of claim 1, in which the rules data includes business rules associated with the health insurance industry.

8. The method of claim 1, in which the rules data includes validation rules to validate data captured from the applicant at runtime.

9. The method of claim 1, wherein the page data defines a page to obtain applicant information, a page to obtain health coverage information, a page to obtain health history information, and health insurance rider information.

10. The method of claim 1, wherein the page data defines a page to obtain applicant information, the applicant information selected from the group including name, birth date, age, height, weight, gender, marital status, relation, college-student, tobacco use, and occupation.

11. The method of claim 1, wherein the page data defines a page to obtain address information, contact telephone number, and financial instrument details.

12. The method of claim 1, wherein the page data defines a page to obtain health history information, the health history information relating previous health history of applicants of a health insurance plan.

13. The method of claim 1, wherein the application form is a health insurance plan application form selected from the group consisting of an Individual and Family insurance plan, a short-term insurance plan, a student health insurance plan, and a health care savings plan, and a small business group plan.

14. The method of claim 1, which comprises:
providing the page flow data, the page data and the rules data in a first markup language; and
generating web pages in a second markup language from the first markup language.

15. The method of claim 1, which comprises communicated the first application page and subsequent application pages to the applicant via the Internet.

16. A machine-readable medium embodying instructions which, when executed by a machine, cause the machine to:
access page flow data, page data and rules data stored in a storage media;
generate a graphical user interface (GUI) that provides a first application page to capture data from an applicant, the first page being generated dynamically from the page data;
provide the first application page to a applicant via a network;
monitor entry of application data by the applicant;
process and storing the application data, the processing including
validating the application data based on the rules data; and
identifying at least one subsequent application page based on the application data and the page flow data;
provide the at least one subsequent application page via the network to the applicant, the subsequent application page being generated dynamically from the page data; and
repetitively generate and providing subsequent application pages to the applicant based on the page flow data and the rules data.

17. A system to provide an application form via a network, the system comprising:
a storage access module to access page flow data, page data and rules data stored in a storage media;
a graphical user interface (GUI) module to generate a graphical user interface that provides a first application page to capture data from an applicant, the first page being generated dynamically from the page data;
an interface module to provide the first application page to the applicant via a network;
a monitoring module to monitor entry of application data by the applicant;
a storage module to store the application data; and
a processing module to:
validate the application data based on the rules data; and
identify at least one subsequent application page based on the application data and the page flow data,
the interface module providing the at least one subsequent application page via the network to the applicant, the subsequent application page being generated dynamically from the page data, and the processing module configured to repetitively generate and provide subsequent application pages to the applicant based on the page flow data and the rules data.

18. The system of claim 17, wherein the page flow data, the page data and the rules data is Extensible Markup Language (XML) data, the processing module being configured to:
access the page flow data, the page data and the rules data in XML;
generate HTML pages from the XML, the HTML pages being generated dynamically in response to the application data, the page flow data, the page data and the rules data; and
provide the HTML pages to the applicant via the network.

19. The system of claim 17, wherein the page flow data, rules data and the page data in the storage media provides an abstraction layer between an application form and an HTML page generated dynamically at runtime.

20. The system of claim 17, wherein:
core-data identifying data that is common to a plurality of application forms is accessed; and
other-data that is specific to an associated application form is accessed.

21. The system of claim 17, in which the page flow data defines one or more follow-up reference pages which are specific to application data requested on an associated page.

22. The system of claim 21, wherein the rules data includes business rules associated with a specific provider application form provider.

23. The system of claim 17, in which the rules data includes business rules associated with the health insurance industry.

24. The system of claim 17, in which the rules data includes validation rules to validate data captured from the applicant at runtime.

25. The system of claim 17, wherein:
the page flow data, the page data and the rules data is provided in a first markup language; and
web pages are generated in a second markup language from the first markup language.

26. The system of claim 17, wherein the network is the Internet and the application form is an online application form.

27. A system to build an application form, the system including:
means for accessing page flow data, page data and rules data stored in a storage media;
means for generating a graphical user interface (GUI) that provides a first application page to capture data from an applicant, the first page being generated dynamically from the page data;
means for providing the first application page to the applicant via a network;
means for monitoring entry of application data by the applicant;
means for processing and storing the application data, the processing including
validating the application data based on the rules data; and
identifying at least one subsequent application page based on the application data and the page flow data;
means for providing the at least one subsequent application page via the network to the applicant, the subsequent application page being generated dynamically from the page data; and
means for repetitively generating and providing subsequent application pages to the applicant based on the page flow data and the rules data.
